(19) United States
(12) Patent Application Publication
(10) Pub. No.: US 2012/0285896 A1
(43) Pub. Date: Nov. 15, 2012

(54) SYSTEM AND METHOD TO MEASURE HYDROCARBONS PRODUCED FROM A WELL

(75) Inventor: Richard Black, Houston, TX (US)

(73) Assignee: CROSSSTREAM ENERGY, LLC, Laredo, TX (US)

(21) Appl. No.: 13/458,987

(22) Filed: Apr. 27, 2012

Related U.S. Application Data
(60) Provisional application No. 61/485,479, filed on May 12, 2011.

(51) Int. Cl. B01D 35/157

(52) U.S. Cl. 210/741; 210/104; 210/101

(57) ABSTRACT

A method and system for metering liquid production at a well comprises an actuated back pressure control valve, a liquid pump, a liquid flow meter and a pressure sensor, both intermediate the liquid pump and the back pressure control valve, and a separator having a liquid discharge conduit, a pressure sensor and a liquid/gas interface sensor disposed to monitor a section of the separator. The liquid pump receives a stream of liquid removed from the monitored section of the separator and moves the liquid stream through the flow meter and the back pressure control valve. A controller receives signals from the pressure sensors and the interface sensor, and operates the liquid pump at a speed to maintain an interface in the monitored section within a predetermined range while positioning the back pressure control valve to maintain the pressure at the flow meter above a pressure at which bubbles may form.

### STATEMENT OF RELATED APPLICATION

This application depends from and claims priority to U.S. Provisional Application No. 61/485,479 filed on May 12, 2011.

### BACKGROUND

1. Field of the Invention

This invention relates to a system and a method to measure liquid, such as oil, produced from an earthen well drilled into the Earth's crust.

2. Background of the Invention

Earthen wells are drilled into the Earth's crust to access mineral deposits such as oil and gas. Technological advances in drilling technology have enabled sections of a well to be drilled horizontally, or at a highly-deviated angle from vertical, and within a targeted geologic formation to dramatically increase the surface area through which fluids residing in the geologic formation (hydrocarbons) may feed into the completed section of the well. Where wells are drilled in geologic formations having favorable properties such as, for example, shale, the formation may be hydraulically fractured to dramatically decrease resistance to the flow of fluids residing in the formation into the well to increase production rates.

For a well producing liquid comprising lighter hydrocarbon components such as, for example, propane and ethane, the operating pressure in a separator to which the well is produced determines the extent to which these lighter hydrocarbon components are allowed to evaporate into a gas phase. At high pressure in the separator, the liquid phase emerging from the separator has a high bubble point pressure because the high pressure suppresses evaporation of the lighter hydrocarbon components into the gas phase. At low pressure in the separator, the liquid phase emerging from the separator has a low bubble point pressure because the low pressure promotes evaporation of the lighter hydrocarbon components into the gas phase.

Conventional field production facilities utilize multiple separators arranged in sequence to stepwise de-pressure the liquid phase. A separator is generally sized to provide a predetermined residence time for a given flow rate of production to be gravity separated therein. A two-phase separator includes a liquid section near the bottom of the separator and a vapor section near the top. A three-phase separator includes a water section, or water boot, at the bottom, a vapor section near the top and an oil section generally intermediate the water section and the vapor section. In a three-phase separator, a weir may be disposed as a barrier to isolate an oil section from a water section and positioned to facilitate the removal of a top layer of oil floating on water to the oil section. It will be understood that a conventional separator may further include mist (coalescence) pads, interface sensors and control valves to maintain a gas/liquid interface and an oil/water interface within certain operating ranges.

In conventional field production facilities with two or more separators arranged in sequence, a high-pressure separator receives the full well stream production from a well through a flow line and separates the full well stream production into a high-pressure gas stream and a high-pressure liquid stream or, where a three-phase separator is used, a high-pressure gas stream, a high-pressure oil stream and a water stream. The liquid stream (or the oil stream) is controllably removed from a high-pressure separator through a dump-valve that cooperates with a controller and a liquid/gas interface sensor, such as a float assembly, to maintain the liquid/gas interface within a predetermined operating range. The liquid (or oil) is generally piped from the high-pressure separator to an intermediate-pressure separator operating at a pressure substantially below the pressure of the high-pressure separator. In the intermediate-pressure separator, the lighter hydrocarbon components of the liquid (or oil) evaporate to form an intermediate-pressure gas stream, substantially richer (energy content per scf) than the gas stream from the high-pressure separator, and a liquid/gas interface is established and maintained within the intermediate-pressure separator using a control valve cooperating with an interface sensor.

Gas discharged from the intermediate-pressure may be vented or, more likely, incinerated to minimize the environmental effect. In some cases, some of the gas discharged from the intermediate-pressure separator may be compressed to boost the pressure of the gas to a pressure sufficient to permit the boosted portion of the gas stream from the intermediate-pressure separator to be combined with the gas stream discharged from the high-pressure separator. Liquid (or oil) may be removed from an intermediate-pressure separator through a control valve that cooperates with a liquid/gas interface sensor in the intermediate-pressure separator to maintain a liquid/gas interface within the intermediate-pressure separator in the same manner as with the high-pressure separator. The liquid (or oil) removed from the intermediate-pressure separator may be piped to a low-pressure separator for further processing.

In the low-pressure separator, the lighter hydrocarbon components of the liquid (or oil) stream evaporate to form a very rich gas stream and a liquid/gas interface is established and maintained within the low-pressure separator using a control valve cooperating with a liquid/gas interface sensor. The gas stream removed from the low-pressure separator is vented or, more likely, incinerated to minimize environmental effects. In some cases, the gas discharged from the low-pressure separator may be compressed to allow it to be combined with the gas stream discharged from the intermediate-pressure separator or, alternately, with the gas stream discharged from the high-pressure separator. The liquid (or oil) stream is removed from the low-pressure separator through a control valve cooperating with a liquid/gas interface sensor in the same manner as with the high-pressure separator and the intermediate-pressure separator. The liquid (or oil) stream removed from the low-pressure separator is piped to a stock tank at the well maintained at or very near atmospheric pressure.

The liquid (or oil) that accumulates in the stock tank is periodically unloaded to a mobile tanker for sale and shipment via truck or train to a refinery. It will be understood that, where the liquid is a mixture of oil and water, the water can be separated from the oil in transport or at the destination where the liquid is unloaded from the mobile tanker. Alternately, the stock tank can be drained from the bottom to eliminate the water from the liquid mixture prior to loading the oil onto the mobile tanker. The stock tank may be equipped with a floating or a fixed roof to facilitate the application of blanket gas at a pressure of generally between 0.05 and 0.5 pounds per square inch to prevent air from entering the tank during unloading. The gas in the stock tank when pressured in excess of the blanket gas pressure will be vented or, in some cases, incinerated to minimize environmental effect. In some cases, the stock tank may be equipped with a vapor recovery unit (VRU) to recover and compress at least some of the rich, hydrocarbon gas that evaporates from the oil stored in the stock tank to a pressure high enough so that the compressed gas can be combined with the gas stream from the low-pressure separator. A VRU for a stock tank is expensive to purchase, install and to operate because of the large compression ratio required to compress nearly-atmospheric gas off the stock tank to the pressure of the gas stream from the low-pressure separator. Generally, the cost of operating a VRU will exceed any economic benefit of capturing the hydrocarbons that evaporate in the stock tank. As a result, many operators forego the capture of stock tank vapors and instead incinerate stock tank vapors, thereby resulting in unwanted environmental emissions.

The revenue obtainable from the purchaser such as, for examples, a refinery, pipeline operator, or trader, for a given volume of oil is generally lower where light hydrocarbon components (such as ethane and propane) remaining in the oil raise the vapor pressure of the oil above a specified threshold. Typically, a purchaser will reduce the price paid to a producer for a given volume of oil where the vapor pressure exceeds an optimal vapor pressure threshold or range. For this reason, it is advantageous for the producer to stabilize the oil prior to sale or transfer by extracting lighter hydrocarbons from the oil prior to delivery. Preferably, the oil can be stabilized in a manner that captures the lighter hydrocarbon components for delivery to a market without excessive processing costs and without undue investment in production facilities (for example, multiple separators and related scrubbers, compressors, valves, stock tanks and an incinerator) for each individual lease or each individual well.

An advantage obtained by the use of conventional production facilities, including a stock tank, is that a stock tank facilitates the measurement of produced oil stored in the stock tank so that the owner of the mineral lease from which the oil is produced can be credited with the correct amount of royalties. With a cylindrical stock tank, for example, the volume of oil in the stock tank can be determined both before and after a volume of oil is pumped from the stock tank into a mobile tanker for transport to a purchaser. As a result, a stock tank at the well surface location provides a method of accurately determining royalties to be paid to the owner of the lease from which a well produces.

Disadvantages of the use of conventional production facilities and a stock tank include economic loss and environmental pollution. For example, the use of a high-pressure separator, an intermediate-pressure separator and then a low-pressure separator to stepwise de-pressure produced liquid (or oil), and the use of an intermediate-pressure gas compressor, a low-pressure gas compressor, and perhaps a VRU to consolidate multiple gas streams into a single high-pressure gas stream, require large investments in compressors, scrubbers, piping, sensors, control instruments and valves, and these components then require numerous gaskets, flanges and packing glands in order to minimize the unwanted release of environmentally-harmful hydrocarbons such as volatile organic compounds (VOCs). In addition, motors needed to drive compressors require large amounts of energy and, depending on the energy source, may result in the release of additional unwanted combustion products into the environment. When a compressor or a VRU fails, the lighter hydrocarbon components that inevitably evaporate from produced oil must be incinerated to sustain production, thereby resulting in further unwanted emissions. These sources of VOC emissions, combustion products and incinerator emissions must be tracked and monitored, and additional pieces of equipment such as compressors, stock tanks and related support equipment must be maintained and periodically tested, and the results of the tests must be recorded and submitted in support of environmental compliance reports to federal and state environmental agencies.

Another costly consequence of using conventional production facilities for producing a well relates to excessive volatility deductions for oil delivered to a purchaser from a stock tank. The use of conventional production facilities causes lighter hydrocarbon components, such as ethane and propane, to be retained in the oil in concentrations sufficient to elevate the vapor pressure of the oil beyond the optimal level for refining. Merely de-pressuring oil by, for example, storing it in a stock tank, does not mean that 100% of the lightest hydrocarbon components are removed from the de-pressured oil. The retention of even small concentrations of light hydrocarbon components in the oil dramatically raises the vapor pressure of the oil beyond the optimal level for refining. In addition to unwanted deductions in the price obtainable for oil sold to a purchaser, some pipeline operators impose strict limits on the vapor pressure of oil to be shipped through pipelines to prevent entrained light hydrocarbon components from evaporating and creating a gas phase that impairs pipeline capacity and operations.

There is a need, therefore, for a method and a system to produce a well in a manner that reduces unwanted environmental emissions, to facilitate the accurate determination of royalties to be paid to the mineral lease owner(s), and to reduce the environmental compliance burden on the operator of the production facilities used to produce the well. There is a need, therefore, for a method and a system to produce a well in a manner that reduces the considerable up-front investment required to purchase, fabricate, install and operate conventional production facilities.

There is a further need for a method and system of aggregating oil streams from multiple wells to enable economical conditioning of the aggregated oil stream to conform the vapor pressure and to thereby avoid deductions in the price obtainable from a purchaser upon delivery of the oil. It should be understood that such a method and system requires that the oil be accurately metered prior to being aggregated and conditioned to ensure accurate determination of royalties due to lease owners.

### SUMMARY

The present invention provides a method and a system for producing oil that satisfies some or all of the aforementioned needs. The present invention provides a method of and a system for maintaining the position of a liquid/gas interface within a separator within a given range. The present invention provides a method of accurately metering oil at a well as it is removed from a separator and without de-pressuring the oil for storage in a stock tank. The present invention comprises a method of economically reducing environmental emissions associated with oil production while providing for the accurate determination of royalties due the lease owner. The present invention provides a method of simultaneously reducing capital investment in field production facilities needed for producing multiple wells while eliminating sources of unwanted environmental emissions. The present invention provides a method of and a system for obtaining greater utility from production facilities operated at the lease, lower investment in production facilities and a greater return on investment in production facilities used to produce the lease. These advantages are obtained by providing a production facility system that enables an operator to economically and reliably turndown (i.e., reduce capacity of) the production facility as the production capacity of the well declines. By providing only as much production facility capacity as is actually needed, the overall investment in a plurality of wells can be minimized and the return on investment in production facilities can be increased. This aspect of the invention is especially beneficial where oil-producing wells exhibit a steeply-declining production capacity with an inordinately large portion of the total recoverable hydrocarbons produced within months or even weeks of the onset of production. This type of production capacity decline is characteristic of wells that produce from fractured shale formations.

### BRIEF DESCRIPTION OF THE DRAWINGS

FIG. 1 is a side elevation view of a first separator and a second separator sequentially coupled one after the other as they are used in a conventional production facility sized to produce the maximum rate obtainable in the production cycle of a lease.

FIG. 2 is an end elevation view of the first separator and first skid.

FIG. 3 is a side elevation view of one embodiment of a first skid-mounted separator and related equipment that may be used to implement the method and system of the present invention.

FIG. 4 is an elevation view of one embodiment of a docketing station that can be used to couple to the first skid-mounted separator and related equipment of FIG. 3 that may be used to implement the method and system of the present invention.

FIG. 5A is a perspective view elevation view of one embodiment of an oil pressure boost pump and related pump motor supported on the embodiment of the first skid of FIG. 3, the oil pressure boost pump comprising a gear pump.

FIG. 5B is a perspective view elevation view of one embodiment of an oil pressure boost pump and pump motor supported on the embodiment of the first skid of FIG. 3, the oil pressure boost pump comprising a centrifugal pump.

FIG. 6 is a schematic illustrating the input and/or output connections of a central programmable logic controller (controller) electronically coupled to the pump motor, the oil sampler, an interface sensor and an emergency shut-down (ESD) system.

FIG. 7 is a side elevation view of an embodiment of an oil stabilizer that may be used at a central oil conditioning facility fed by the oil stream from the first skid-mounted separator of FIG. 3, via the oil gathering pipe, and by additional oil streams from separators at other leases aggregated together to form a large oil stream to apply economies of scale to the oil stabilization process.

FIG. 8 is a side elevation view of an embodiment of a second skid supporting an oil pressure boost pump, a pump motor, a flow meter and an oil sampler for connecting to a separator supported off the skid.

FIG. 9 is an elevation view of one embodiment of a docking station to couple to the equipment supported on the second skid of FIG. 8 that may be used to implement an alternate embodiment the method and system of the present invention.

FIG. 10 is a side elevation view of an embodiment of a third skid supporting a second, turndown separator, smaller than the separator on the skid in FIG. 3, and related equipment with the third skid supported on an embodiment of a skid support at the docking station of FIG. 4.

FIG. 11 is a high-level flow chart illustrating an embodiment of a method for allocating hydrocarbons to a well on a mineral lease produced using the methods and systems of the present invention.

FIG. 12 is a high-level flow chart illustrating an embodiment of a method for determining the hydrocarbon production for a well by metering the liquid at the well surface location in accordance with the present invention.

### DETAILED DESCRIPTION

The present invention provides a method of economically and environmentally optimizing production facilities for producing wells drilled in oil-bearing geologic formations. In one embodiment, the present invention provides an improved method of controlling the liquid (or oil) level in a separator used to process production from a well while accurately measuring, at a high pressure, liquid (or oil) produced by the well.

The disclosure that follows uses the term “liquid” in referring to a fluidic material produced from a geologic formation and separated from a gas phase in a separator. The term “liquid,” as used herein, may refer to oil or, in the alternative, the term “liquid” may refer to a mixture of water and oil that, for example, might be obtained from a two-phase separator.

The measurement of liquid production at high pressure prevents the need for a large number of vessels and related processing equipment to produce the well, and prevents the need for a much larger investment in production facilities to produce the well. The measurement of the liquid production at high pressure also prevents the need to de-pressure the liquid produced by the well so that it can be stored and measured using a stock tank.

In one embodiment, the present invention may be used to reduce the amount of the investment in production facilities at or near a well surface location by reducing the size and number of vessels and related equipment needed to process the production rate expected from the well. In one embodiment of the method and system of the present invention, a first, high-capacity production facility can be used early in the production cycle to produce the maximum production rates expected from the well and a second, reduced capacity production facility can be subsequently installed to free up the first, high-capacity production facility for use at other wells that produce at sufficient rates to warrant a high-capacity facility. The first, high-capacity production facility and the second, reduced or “turndown” capacity production facility can, in one embodiment, be supported on skids to be sequentially coupled to a docking station at the well surface location. This arrangement provides for a “plug-out / plug-in” substitutability of the second “turndown” production facility for the first, high-capacity production facility, thereby allowing the more costly high-capacity facility to be used at another well.

Accordingly, the method and system of the present invention enables the exploitation of mineral deposits using a more economical and environmentally safer production facility that facilitates the accurate determination of royalties due to be paid to the lease owner while reducing environmental emissions and reduced overall investment.

One embodiment of the method of producing a well comprises the steps of: providing a first separator located generally near the surface location of a well; providing a pump to increase the pressure of a liquid stream leaving the separator through a liquid discharge pipe to suppress the formation of gas bubbles in the liquid discharge pipe immediately downstream of the pump; coupling a flow meter to measure the rate of the liquid stream in the liquid discharge pipe downstream of the pump; connecting a flow line to an inlet pipe on the first separator to deliver full well stream production from the well to the separator; connecting the liquid discharge pipe to a liquid gathering pipe; connecting the liquid gathering pipe to a central conditioning facility; connecting a gas discharge pipe through which gas is discharged from the separator to a gas gathering pipe; receiving full well stream production fluid from the well through the flow line and separator inlet pipe and into the separator; removing a gas stream from the separator through the separator gas discharge pipe and the gas gathering pipe; removing a liquid discharge stream from the separator through the liquid discharge pipe and the pump to the liquid gathering pipe; using the pump to increase the pressure of the liquid discharge stream at the liquid flow meter; using the flow meter to measure the liquid removed from the separator; recording the flow rate of the liquid removed from the separator through the pump; moving the liquid from the liquid gathering pipe to the central conditioning facility; combining the liquid stream with one or more additional liquid streams from one or more additional wells delivered to the central conditioning facility to form an aggregated liquid stream; using a stabilizer at the central conditioning facility to remove lighter hydrocarbon components and to thereby adjust the composition of the aggregated liquid stream so that the vapor pressure of the conditioned stream is favorable for selling the conditioned stream to a purchaser; delivering the conditioned stream from the central conditioning facility to the purchaser; using data obtained and stored by the meter to determine the amount and nature of the hydrocarbons produced from the well during a time period; and determining a royalty to be paid to the owner of the lease from which the well produces as a portion of revenues obtained from the sale of the conditioned oil and associated gas.

In one embodiment of the invention, the method further comprises the step of providing an automated liquid sampler downstream of the pump to periodically extract and store a sample of liquid from the liquid stream discharged from the separator and pumped through the pump. In one embodiment, the separator, the pump, a pump motor, the automated liquid sampler and related equipment are supported on a skid. In an alternate embodiment, the pump, a pump motor, the automated liquid sampler and related equipment are supported on a skid positioned proximal an existing separator so that the liquid discharged from the separator can be easily routed to an inlet of the pump on the skid. In another embodiment of the method and system of the present invention, a docking station is provided to position an end of a flow line adjacent a skid support on which a skid supporting the separator is supported. In another embodiment of the present invention, a docking station is provided to position an end of a liquids gathering line adjacent a skid support on which a skid supporting a pump and a flow meter are supported. The pump may receive and boost the pressure of a liquid stream from a separator to facilitate metering at a pressure above the bubble point pressure of the liquid stream.

In one embodiment of the method of the present invention, a liquid level in a section of the separator may be maintained within a predetermined operating range using a liquid/gas interface sensor, such as a guided wave radar device, coupled through a controller and a current conditioning device, such as a variable frequency drive, to a pump motor that operates the pump. The liquid/gas interface sensor may be mounted in or near the top of the separator to monitor the liquid/gas interface position in, for example, a monitored section of the separator in which oil resides, and to maintain the liquid/gas interface position within a desired operating range. In one mode of operation, the liquid/gas interface sensor detects an elevated level in the monitored section of the separator and generates a corresponding signal to the controller. The controller processes the signal received from the liquid/gas interface sensor and generates a corresponding speed signal to the current conditioning device. The current conditioning device then provides a conditioned current to a pump motor that is coupled to operate the pump, for example, to rotate the input shaft of the pump at an increased rate to increase the rate at which liquid is removed from the monitored section of the separator. The pump operated by the pump motor has a pump inlet, such as a flange, disposed in fluidic communication with the monitored section of the separator and a pump outlet, such as a discharge flange, in fluidic communication with a flow meter. In response to an elevated position detected by the liquid/gas interface sensor, the processor generates a signal to increase the operating speed of the pump and to increase the rate at which liquid is removed from the monitored section of the separator through the pump and through the liquid discharge pipe. An increased liquid removal rate will generally result in a reduced or corrected position of the liquid/gas interface in the monitored section of the separator which, upon being detected by the liquid/gas interface sensor, causes the liquid/gas interface sensor to generate a corresponding signal to the controller which, in turn, generates a revised signal to decrease the speed of the pump motor and the pump, and to thereby slow the rate of removal of liquid from the monitored section of the separator. The pump operates to maintain the pressure of the liquid in the flow meter disposed downstream of the pump above the bubble point pressure of the liquid to suppress the formation of bubbles in the liquid and to thereby facilitate accurate measurement.

The corrective action described above is automatically implemented using the equipment described above, or equivalents thereof, and will maintain the position of the liquid/gas interface in the monitored section of the separator within a desired operating range. It will be understood that the current conditioning device, such as a variable frequency drive, may be disposed at the well surface location at a safe distance from the hydrocarbon processing equipment (separator, pump, flow meter, etc.) for purposes of safety, and that the pump motor will be of an explosion proof design.

The liquid/gas interface sensor may, in some embodiments of the method and system of the present invention, be mounted on the separator using a bridle and a related piping loop external to the separator if a top nozzle, man way or other structure to facilitate internal mounting within the separator vessel is not available or otherwise not convenient. The liquid/gas interface sensor may generate either an analog or digital signal to a controller and, in one embodiment of the present invention, the controller may generate a variable frequency signal to directly control the speed of the pump motor. Alternately, the controller may simply provide a signal to a separate controller that generates, for example, a variable frequency signal to the pump motor to operate the pump motor and the pump coupled thereto at the desired speed.

The pump and pump motor may be coupled one to the other using a shaft fitted with circumferential seals to contain the pressure within the pump case or, alternately, an output shaft of the pump motor may be magnetically coupled to an input shaft of the pump using, for example, a plurality of corresponding magnets or, alternately, rare earth magnets disposed within a non-magnetic case (such as stainless steel) to provide for torque transmission from the pump motor to the pump (or pump input shaft) without the use of fluidic seals to contain the pressure within the pump case. The above-described steps of monitoring the liquid/gas interface position in the monitored section of the separator using a liquid/gas interface sensor, detecting a condition corresponding to an excessive level in the monitored section of the separator, using the liquid/gas interface sensor to generate a signal to the controller, using the controller to generate a signal to the pump motor and then again using the liquid/gas interface sensor to sense a corrected level in the monitored section of the separator may, in one embodiment of the present invention, be repeated as part of a continuous system for monitoring and controlling the position of the liquid/gas interface within the separator and for boosting the pressure of the liquid stream removed from the monitored section of the separator to a pressure above the bubble point pressure to facilitate accurate metering of the liquid stream at the well surface location.

The equipment used to implement this system may be used to perform other control tasks. For example, the controller used to receive the signal from the liquid/gas interface sensor and to generate a corresponding signal to the pump motor may, in some embodiments of the present invention, also be used to control an emergency shut-down (ESD) valve disposed at the wellhead. As another example, the controller may also be used in conjunction with a separator pressure sensor to monitor and control the pressure in the separator by controlling an actuated back pressure valve on a gas discharge pipe through which gas separated from the liquid in the separator is removed from the separator. As another example, the controller may also be used to receive a signal from a pressure sensor disposed to sense the pressure within the separator (or within a pipe carrying fluid discharged from the separator, such as the gas discharge pipe or the liquid discharge pipe), to generate a signal corresponding to the sensed pressure to an actuator on a back pressure control valve disposed in the liquid discharge pipe and downstream of the pump and the flow meter, and to use the signal to position the back pressure control valve to maintain the pressure upstream of the valve and in the liquid discharge pipe at the flow meter at a pressure equal to the sensed pressure plus a predetermined incremental amount of additional pressure to suppress the formation of bubbles. As another example, the controller may be used in conjunction with a separator pressure sensor and a liquid gathering pipe pressure sensor to facilitate control of the pressure of the liquid stream at the flow meter disposed downstream of the pump. As stated above, the pump boosts the pressure of the liquid stream emerging from the separator so that the liquid stream can be metered by the flow meter at a pressure above the bubble point pressure of the liquid. If the pressure in the liquid gathering pipe disposed downstream of the meter is below a desired set point pressure which, according to the example given above, is at a predetermined pressure interval above the bubble point pressure of the liquid (which may be provided by the separator pressure sensor), the controller can be used to modify the position of the liquid back pressure control valve towards closure and to thereby increase and then maintain the pressure at the flow meter above the bubble point pressure. Downstream of the flow meter, the liquid stream will incur a pressure drop across the back pressure control valve and, where the pressure in the liquid gathering pipe downstream of the back pressure control valve is below the bubble point pressure, a portion of the lighter hydrocarbon components of the liquid stream will evaporate within the liquid gathering pipe, but such evaporation will not impair accurate metering of the liquid stream removed from the separator and boosted by the pump.

In one embodiment of the system, a liquid measurement sub-system for determining the mass flow rate and one of the density and the chemical composition of the liquid phase is provided. For example, the liquid measurement sub-system may, in one embodiment, comprise a Coriolis mass flow meter, an automated liquid sampler and a back pressure control valve disposed on one of the liquid discharge pipe or the liquid gathering pipe to receive a stream of liquid removed from the monitored section of the separator. Embodiments of the present invention including the use of a back pressure control valve on the liquid discharge pipe or on the liquid gathering pipe provide the back pressure control valve at a location that is downstream of the pump, downstream of the flow meter and downstream of the automated liquid sampler to facilitate the measurement of the liquid flow rate without error or inaccuracy that would be introduced by the formation of bubbles in the liquid stream. These embodiments utilizing a Coriolis flow meter facilitate both accurate mass flow measurement and liquid density measurement in the Coriolois meter, along with efficient liquid sampling in the automated liquid sampler. Like a back pressure control valve on the gas discharge pipe, a back pressure control valve may be disposed downstream of the pump, the liquid sampler, and the Coriolis mass flow meter, and downstream of the metering sub-system. Alternately, a back pressure control valve may be disposed off-skid from the pump, the automated liquid sampler and the pump motor, and on the liquid gathering pipe. It will be understood that the purpose of the back pressure control valve on the liquid discharge pipe or the liquid gathering pipe is to provide a pressure that facilitates the accurate metering of the liquid stream removed from the monitored section of the separator by isolating the portion of the liquid stream at and upstream of the meter from a pressure in the liquid gathering pipe that may be below the bubble point pressure of the liquid stream. The back pressure control valve, whether it be provided immediately downstream of the liquid metering sub-system and on a skid, or off the skid at on the liquid gathering pipe, may be used to provide sufficient back pressure on the portion of the liquid stream at the flow meter so that the boost in pressure provided by the pump facilitates accurate metering by ensuring that the metered liquid stream is above the bubble point pressure of the liquid.

The operation and control of the back pressure control valve may be understood by consideration of an example of how fluctuations in the pressure in the liquid gathering pipe might otherwise impair the accurate metering of the liquid stream emerging from the separator but for the present invention. Assuming a pressure sensor detects a separator pressure of, for example, 250 psig, and a second pressure sensor detects a liquid gathering pipe pressure (downstream of the back pressure control valve) of 225 psig, it will be understood that at least some of the lighter components of a liquid stream emerging from the separator would evaporate upon exposure to the lower pressure of the liquid gathering pipe, thereby introducing significant metering error at the flow meter. Even with the pump operating to remove liquid from the monitored section of the separator, the pressure at the outlet of the pump would be the same as the pressure in the liquid gathering pipe but for the back pressure control valve. Stated another way, in the absence of a back pressure control valve downstream of the pump and flow meter and upstream of the liquid gathering pipe, the pump would merely remove liquid from the separator and would not necessarily boost the pressure to facilitate accurate metering at the flow meter. The back pressure control valve, then, serves to isolate the outlet of the pump and the flow meter downstream thereof from the liquid gathering pipe pressure. With a back pressure control valve disposed downstream of the pump so that the flow meter is intermediate the pump and the back pressure control valve, and so that the back pressure control valve and the flow meter are intermediate the pump and the liquid gathering pipe, the controller will move the back pressure control valve towards closure in response to a signal from a second pressure sensor indicating that the pressure in the liquid gathering pipe between the pump and the back pressure control valve (as compared to the separator) is below the desired measurement pressure. Positioning the back pressure control valve towards closure will enable the pump to impart a pressure boost to the liquid stream emerging from the separator so that metering of the liquid stream can be accurately performed at a pressure above the bubble point pressure (approximately 250 psig, the separator pressure) of the liquid stream. Downstream of the flow meter, and at the back pressure control valve, the liquid stream will be de-pressured as it enters the liquid gathering pipe, but any gas that evaporates as a result of the pressure drop will not impair accurate metering of the liquid stream.

In another example, the second pressure sensor disposed on liquid gathering pipe may detect a pressure of the liquid in the liquid gathering pipe to be greater than the bubble point pressure of the liquid stream and greater than the separator pressure as detected by a first pressure sensor. For example, the separator pressure detected by the first pressure sensor may be 250 psig and the liquid gathering pipe pressure detected by the second pressure sensor may be 400 psig. In this case, the controller will, in response to the signal from the first and second pressure sensors, generate a signal to the back pressure control valve actuator to position the back pressure control valve to a fully open position so that the discharge pressure from the pump will be the same as the liquid gathering pipe pressure, or 400 psig. It will be understood that, with this control capacity, the controller can variably operate the pump at a speed that is necessary to maintain the liquid/gas interface in the monitored section of the separator within a desired range while the controller (or another, related controller) maintains the position of the back pressure control valve as needed to ensure that the pressure of the liquid stream detected by a second pressure sensor disposed at or near the flow meter remains above the bubble point pressure (i.e., the sensed separator pressure).

It will be understood that the control of the speed of the pump that maintains the position of the liquid/gas interface in the separator within the desired range and the control of the back pressure control valve are not unrelated. For example, an increase in the speed of the pump motor and in the throughput of the pump, to lower an elevated position of a liquid/gas interface in the separator, may require the back pressure control valve to move towards the open position in order to prevent the pressure of the liquid stream at the flow meter from increasing to a level above the safe operating pressure of the piping and equipment. Alternately, a decrease in the speed of the pump motor and the throughput of the pump, to maintain a corrected position of the liquid/gas interface in the separator, may require the back pressure control valve to move slightly towards the closed position in order to prevent the pressure of the liquid stream at the meter from decreasing to a pressure below the bubble point pressure of the liquid. For these reasons, a preferred embodiment of the method of the present invention provides generally continuous monitoring and adjustment of the speed of the pump and in the position of the back pressure control valve downstream thereof.

In addition to these functions, a controller may be programmed and connected to other devices and sensors to provide further benefits. For example, the controller may be programmed to maintain an oil/water interface in a primary section of a three-phase separator, to position a back pressure control valve on the gas discharge pipe, to activate, deactivate and/or adjust the speed of a second pump motor coupled to a second pump operating in parallel to the first pump, to control the injection and concentration of injected chemicals to abate corrosion, scale, paraffin and/or friction, to communicate data indicating the status and/or alarm conditions of equipment at the well site and to activate an ESD to shut in the well when conditions warrant. The controller may also be used to monitor and/or record measurements by the flow meter, to control the gathering of samples by the automated liquid sampler and to operate other equipment that may be provided for the purpose of metering the liquid produced through the separator.

In one embodiment, a measurement sub-system may comprise a volumetric flow meter such as, for example, a turbine meter having a rotary element that spins on an axis disposed generally centrally along an axis of flow. The rotations of the rotary element in a given period of time generally correspond to the volume of liquid moving through the meter. In another embodiment, a measurement sub-system may comprise a positive displacement flow meter such as, for example, an A. O. Smith meter. In other embodiments, a turbine meter or a positive displacement meter may be combined with a densitometer so that, in addition to the volumetric flow rate of the liquid from the separator, the density of the liquid can also be obtained with reasonable accuracy, and the density measurements are combined with the volumetric data from the volumetric flow meter to enhance the overall accuracy of the determination of the amount and quality of hydrocarbons produced from the well.

It should be noted that, where a measurement sub-system comprises a Coriolis meter, there is no need for a densitometer since a Coriolis meter provides density measurements of the liquid flowing through the Coriolis meter. There are several brands of Coriolis meters including MicroMotion®, a brand of mass flow measurement meter sold by Emerson Process Management of Boulder, Colo., USA, that uses the principle that increasing mass flow through a vibrating tube twists the vibrating tube at an increasing and a measurable displacement corresponding to the mass flow rate, and the magnitude of the displacement of the tube can be accurately correlated to enable the accurate determination of the mass flow rate of the fluid flowing through the tube. Periodic sampling of the oil using the automated oil sampler enables an operator to determine the weighted average chemical composition and/or the weighted average density of the liquid samples captured over a time period. These data taken together enable an operator to accurately determine the total mass, volume and chemical composition of liquid flowing through the liquid discharge pipe within a time period of interest. The Coriolis mass flow meter uses magnetic sensors to measure the deflection of the tubes in the meter through which the liquid flows. The sensed deflections are transmitted to the controller and saved to enable the amount of production to be determined. The liquid samples taken in the automated liquid sampler are stored in a storage vessel that is removable from the liquid sampler to facilitate measurement and analysis in a remote laboratory environment, for example, by chromatographic analysis, and the data from the analysis of the aggregated liquid samples may be transmitted to a central controller, along with the data from the Coriolis mass flow meter, to facilitate the determination of hydrocarbon production from the well.

In one embodiment of the system and method of the present invention, a measurement sub-system further comprises an automated liquid sampler. It will be understood that, although a densitometer or a Coriolis mass flow meter may be used to obtain the density of a liquid, obtaining an actual sample of the liquid enables the determination of the chemical composition of the aggregated samples by, for example, chromatographic analysis. Since the value of a given volume or a given mass of hydrocarbons may depend, at least in part, on the chemical composition of the hydrocarbons, two wells producing liquid of identical density may result in different revenues. The controller may be used, in addition to the uses described above, to periodically activate an automated liquid sampler to obtain a sample of the liquid removed from the separator through the liquid discharge pipe. An automated liquid sampler can store multiple samples taken over a period of time in a pressure vessel or a “bomb” that is removable from the automated liquid sampler. The pressure vessel can be periodically replaced, and the accumulated liquid sample in the replaced pressure vessel can be analyzed to obtain a weighted-average chemical composition and/or weighted-average density of the hydrocarbon component of the liquid sample produced by the well. In one embodiment of the method and system of the present invention, a static mixer is disposed upstream of the automated liquid sampler to ensure that obtained and stored samples of the liquid are representative of the liquid being removed from the monitored section of the separator.

In one embodiment of the method of the present invention, the rate or frequency at which the automated liquid sampler takes samples can be tailored to comport with the rate at which liquid flows from the separator and through the automated sampler sample probe by, for example, using data provided from a Coriolis mass flow meter or a volumetric flow meter. In this way, a more representative sample may be accumulated by the automated liquid sampler by taking samples more frequently when the flow rate is higher and less frequently when the flow rate is lower.

Some embodiments of the system and method of the present invention may be implemented using a separator coupled to a pump. The pump cooperates through a controller with a liquid/gas interface sensor that monitors a section of the separator. The controller receives a signal from an interface sensor disposed to monitor the position of a liquid/gas interface within a monitored section of the separator and generates a corresponding signal to the pump motor, which signal may be processed through other devices such as a current conditioning device, to vary the speed of the pump motor and to thereby control the flow rate at which liquid is removed from the monitored section of the separator through the pump. The pump provides favorable conditions (a pressure above the bubble point pressure) for metering the liquid in a meter disposed downstream of the pump but upstream of a back pressure control valve. By eliminating the need to de-pressure produced liquids to near-atmospheric or atmospheric pressure, a portion of the produced hydrocarbons can be retained in the liquid phase instead of being surrendered to the gas phase by stepwise de-pressuring of the produced liquid. The system and method of the present invention thereby facilitate the accurate metering of the hydrocarbons produced while eliminating the need for a stock tank, an incinerator and intermediate-pressure and low-pressure vessels and related equipment, such as compressors.

A metered liquid stream may be carried away from the well location via the liquid gathering pipe and subsequently commingled with metered liquid streams from similar production facilities disposed at other wells. The commingled stream can be efficiently conditioned and treated at a centralized conditioning facility. For example, using economies of scale, an operator can capture at a central conditioning facility what would have otherwise been vented and/or incinerated hydrocarbon gas, and the operator can thereby stabilize the remaining liquid phase to adjust the vapor pressure and, at the same time, maximize revenues received upon sale of the liquids to a purchaser. At the same central conditioning facility, the commingled liquid stream can be subjected to separation to remove water and other non-hydrocarbon components. It will be understood that the throughput or loading of such a centralized conditioning facility will be less affected by a decline or interruption in production of any individual well because declining production from a first well is likely to be replaced or offset by an increase in production from a second well that contributes to the overall throughput at the central conditioning facility. This benefit enables an operator to obtain a substantially greater return from an investment in the centralized conditioning facility because it can be efficiently and continuously loaded to achieve a high facility utilization rate as opposed to the less cost-effective alternative of investing in numerous smaller and less efficient facilities installed and operated at each individual well.

As another benefit, the method and system of the present invention provides for a greatly-reduced facilities footprint at the well (approximately 5 to 8% of that of a conventional production facility), the method and system provide for reduced facilities equipment and installation investment for the production of each well. A single production facility built in accordance with some embodiments of the system and method of the present invention can be relocated and re-used for the production of multiple wells.

The method and system of the present invention facilitates the efficient removal and replacement of components to accommodate facilities turndown as a production capacity of a well declines. For example, many wells may exhibit a steep decline in production within weeks or months of the onset of production. Some or all of a separator, liquid pump, a liquid meter and an automated liquid sampler may be disposed on a first skid and connected to a well at the onset of production at a high initial production rate. Once the production rate declines into a range corresponding to a turndown mode, some or all of this equipment may be replaced with smaller and less expensive counterparts with a lower throughput capacity, and the replaced, larger-capacity equipment can be used at another well to facilitate initial production rates at the well. Where the equipment is conveniently arranged on a skid, a second, turndown skid supporting, for example, a smaller separator, a smaller pump, and a smaller liquid meter, can be brought to the well location, put in the place previously occupied by the first skid and connected to the same flow line, gas gathering pipe and liquid gathering pipe that was connected to the first skid.

In one embodiment of the method and system of the present invention, the modular or staged approach to the installation, use, substitution and removal of production facilities may be best achieved by positioning equipment and, more specifically, connections to and from the equipment, in the same locations, relative to the skid support, on the equipment used for initial production of a well and on the equipment used to turndown the capacity of the production facilities. For example, if an embodiment of a first skid were to support a separator, a liquid pump, a liquid meter, an automated liquid sampler and a back pressure control valve in certain positions on the first skid so that a flow line from the well is conveniently connectable to the separator inlet, the liquid gathering pipe that receives metered liquid is conveniently connectable to the (downstream end of the) back pressure control valve, and the gas gathering pipe that receives separated gas is conveniently connectable to the gas discharge pipe that couples to the gas discharge flange on the separator, then it will be advantageous to position a smaller capacity separator, an associated gas discharge pipe and an associated back pressure control valve in the same relative positions on a second, turndown skid and with the same-sized connections to facilitate connection of the equipment on the turndown skid to the flow line, the gas gathering pipe and the liquid gathering pipe. Similarly, where a three-phase separator is employed, a water gathering pipe may be positioned for connection to a water discharge pipe. It will be understood that this method and system facilitates the convenient and reliable installation, removal and substitution of production facilities and lowers the capital investment required to produce a large number of wells, reduces environmental emissions, maintains the capacity to accurately allocate production back to the well and provides greater revenue through strategic and efficient conditioning of aggregated liquid streams from multiple wells.

In one embodiment of the method and system of the present invention, a chemical injection pump, a chemical injection pump motor and at least one container with a volume of chemical is provided for introducing, at a controllable rate, one or more chemicals into the liquid stream removed from the separator. The chemical may be, for example, an emulsion breaker, a corrosion inhibitor, a scale inhibitor, a paraffin inhibitor, or a friction reducing agent. The chemical(s) to be introduced into the liquid stream removed from the monitored section of the separator depends on the physical characteristics, acidity or alkalinity, salinity or the compositional chemistry of the produced liquids and the problems associated therewith. The rate at which the chemical(s) is introduced into the liquid stream is controllable using the controller to generate a signal to the chemical pump motor that operates the chemical injection pump to operate at a rate that ensures a favorable injection rate and a favorable concentration of the chemical for the specific rate at which the liquid stream is removed from the monitored section of the separator. For example, but not by way of limitation, in response to detection by the liquid/gas interface sensor that the position of the liquid/gas interface within the monitored section of the separator is elevated, a signal corresponding to the elevated position is generated by the liquid/gas interface sensor to a controller. The controller generates a first signal to increase the speed of the liquid pump motor to increase the speed of the liquid pump and to thereby increase the rate at which liquid is removed from the monitored section of the separator, and the controller generates a second signal to increase the speed of the chemical injection pump motor to increase the rate at which chemical is pumped and introduced into the liquid stream removed from the monitored section of the separator. Later, when the liquid/gas interface sensor detects a corrected position of the liquid/gas interface in the monitored section of the separator and the rate at which liquid is removed from the monitored section of the separator is downwardly restored, the rate at which the chemical is injected is also downwardly restored. In this manner, the embodiment of the method and system of the present invention conserves chemical by ensuring that an excessive amount of chemical is not injected into the liquid stream and, at the same time, prevents unwanted emulsions, scale, corrosion, paraffin formation, flow resistance or other problems to be abated by the chemical by ensuring that an insufficient rate of chemical injection is avoided during accelerated periods of removal of liquid from the monitored section of the separator. Those skilled in the chemical arts will understand that conventional chemical injection pumps are generally operated to deliver a sufficient amount of chemical agent for the maximum anticipated rate of flow of the liquid stream being treated using the chemical agent, and that, at rates lower than the maximum anticipated rate, chemical is wasted by maintenance of the chemical injection rate at the higher, fixed rate. By using the controller to determine the speed at which the liquid pump motor and the liquid pump operate, and by using the controller to continuously or intermittently tailor the chemical injection rate in accordance with the liquid pump rate, an operator can realize a significant cost savings by preserving chemical resources.

Features and elements of embodiments of the method and system of the present invention may be better understood by reference to the appended drawings, which are discussed in connection with certain aspects of the present invention that follow. These appended drawings are not meant to be limiting of the invention, which is limited only by the claims that follow.

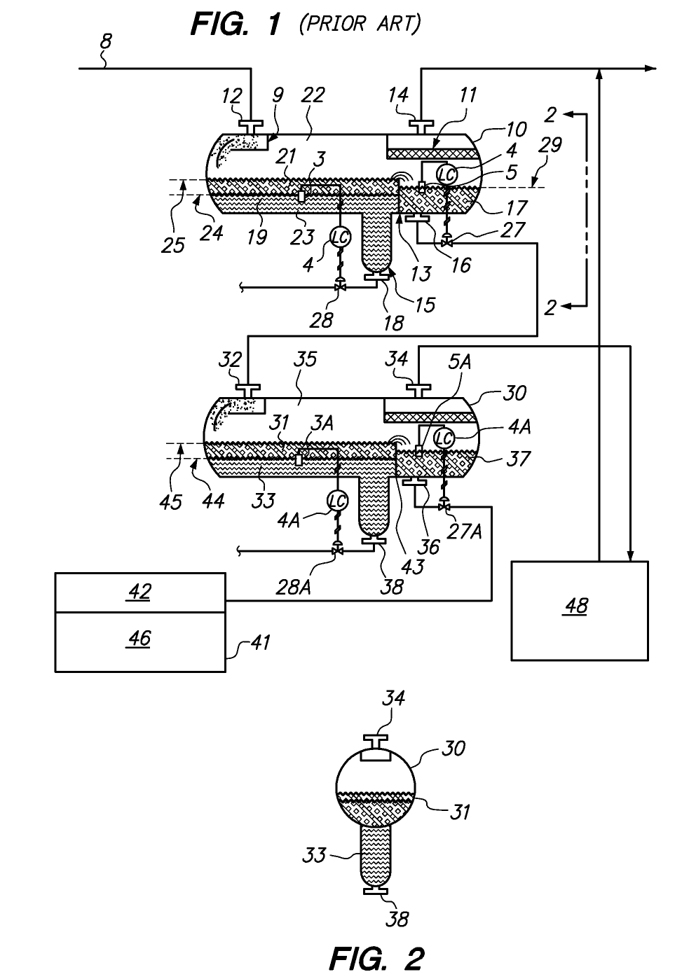

FIG. 1 illustrates conventional production facilities used to produce wells. FIG. 1 is a side elevation view of a first separator 10 and a second separator 30 sequentially coupled one after the other as these separators are used in a conventional production facility. The first and second sequential separators 10 and 30 operate at different pressures, the pressure of high-pressure separator 10 being substantially higher than the pressure of low-pressure separator 30. The high-pressure separator 10 comprises an inlet flange 12, a gas discharge flange 14, an oil discharge flange 16, a water discharge flange 18 on a water boot 15, and a weir 13 to divide an oil section 17 from a produced liquid section 19. It will be understood that full well stream from a flow line 8 that is connected to a wellhead (not shown) provides produced fluids into the separator 10 and against the impingement deflector 9. In the separator 10, water 23 is gravity separated from oil 21 and gas 22. Oil 21 spills over the weir 13 and into the oil section 17 while the denser water 23 sinks into the water boot 15. Gas 22 moves through the mist eliminator 11 and is discharged through the gas discharge flange 14. Oil 21 is discharged from the oil section 17 through the oil discharge flange 16 and water 23 leaves the water boot 15 through the water discharge flange 18.

A liquid/gas interface 25 is established between the oil 21 and the gas 22, while an oil/water interface level 24 is established between the oil 21 and water 23. The oil level 29 in the oil section 17 may be monitored using instruments such as, for example, a float 5 and level control sensor 4 coupled thereto. Similarly, the oil/water interface 24 may be monitored using a float 3 and level control sensor 4 coupled thereto. The signals generated by the level control sensors 3 and 4 are transmitted, either via wire or wirelessly, to actuated valves 28 and 27, respectively, fluidically coupled to the water discharge flange 18 and the oil discharge flange 16, respectively, that will open and close to adjust the associated interface level 24 and oil level 29, respectively, within the separator 10.

The oil discharged from the oil discharge flange 16 through the actuated valve 27 associated with the first separator 10 is routed to the inlet flange 32 on the second separator 30 where an oil layer 31 will float above a water layer 33 and a gas phase 35 will remain above the oil layer 31. The oil stream emerging from the first separator 10 is again subjected to gravity separation, this time at a lower pressure in the second separator 30 as compared to the pressure of the first separator 10. It will be understood that, upon depressurization in the second separator 30, lighter components of the oil will evaporate to form a gas phase 35 in the second separator 30. In addition, any water that may have been entrained in the oil spilling over the weir 13 of the first separator 10 can be gravity separated out of the oil phase in the second separator 30. Gas is discharged from the second separator 30 through the gas discharge flange 34 and oil from the oil layer 31 will spill over the weir 43 into the oil section 37 of the second separator 30 before being discharged through the oil discharge flange 36. Water from the water layer 33 in the second separator 30 is discharged through the water discharge flange 38. In the same manner as described above with respect to the first separator 10, the liquid/gas interface level 45 and the water/oil interface level 44 in the second separator are controllable using floats 3A and 5A, level control sensors 4A and actuated valves 28A and 27A.

FIG. 2 is a sectional elevation view of the embodiment of the second separator 30 of FIG. 1 illustrating the positions of the gas discharge flange 34, the water discharge flange 38, the water layer 33, and the oil layer 31 in the separator 30 as is well-known in the art.

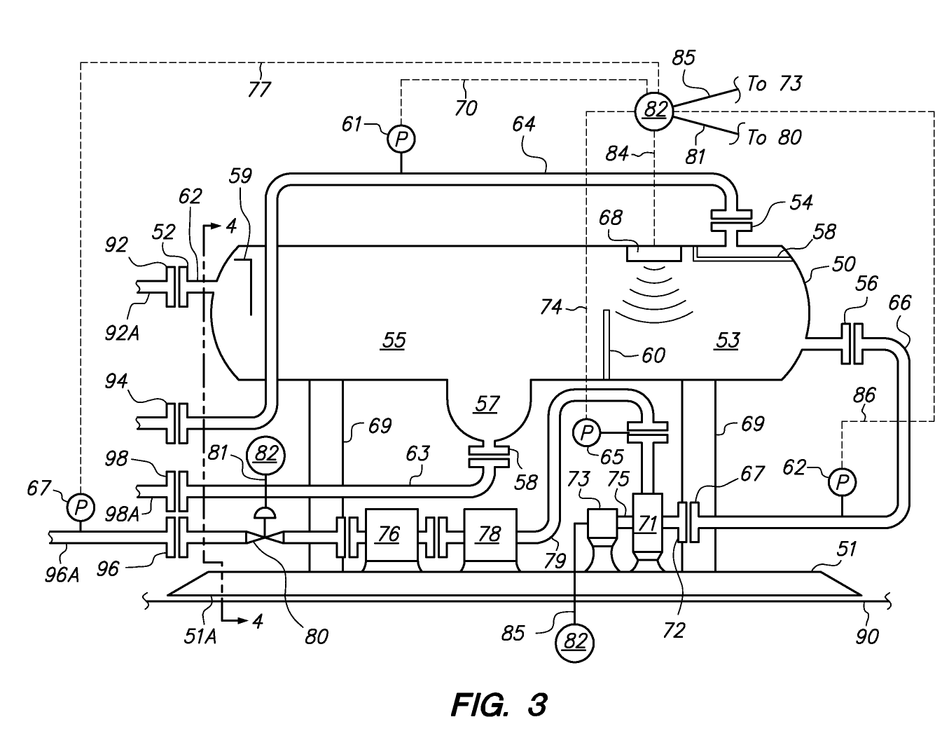

FIGS. 3 through 12 are related to and illustrate embodiments of the method and system of the present invention. FIG. 3 is a side elevation view of an embodiment of a skid-mounted separator 50 and related equipment that may be used to implement one embodiment of the method and system of the present invention. The skid 51 comprises a first end 51A and supports the separator 50 above the skid 51 through a pair of pillars 69 spaced one from the other. A skid support 90 may be provided to support the skid 51. In one embodiment, the skid support 90 is the Earth. The separator 50 comprises an inlet flange 52 connected to a flow line flange 92 disposed at the second end of a flow line (the first end, not shown, being connected to the well), an impingement deflector 59 adjacent thereto, a gas discharge flange 54 connected to a gas discharge pipe 64, a liquid discharge flange 56 connected to a liquid discharge pipe 66, a water boot 57, a water discharge flange 58, a weir 60 disposed intermediate a pump feed section 53 of the separator 50 and a primary section 55 of the separator, a mist eliminator 58, and a liquid/gas interface sensor 68 such as, for example, a guided wave radar interface sensor that generates a signal 84 to a controller 82. The water discharge flange 58 is connected to a water discharge pipe 63 and that an oil/water interface sensor (not shown) may be disposed to access the liquid section 55 of the separator. The oil/water interface sensor (not shown) generates a signal (not shown) to the controller 82 which causes the control valve to open in response to an elevated oil/water interface position, thereby moving water from the liquid section 55 of the separator 50 through the water discharge pipe 63 to maintain the location of the oil/water interface within a predetermined operating range.

A plurality of pressure sensors may also be disposed at various positions to facilitate feedback and control capability. For example, a pressure sensor 62 may be disposed to sense the pressure of the liquid stream removed from the monitored section 53 of the separator 50 through the liquid discharge pipe 66, and to generate a signal 86 corresponding to the pressure in the separator 50 to the controller 82. Alternately, a pressure sensor 61 may be disposed to sense the pressure of the gas stream removed from the monitored section 53 of the separator 50 through the gas discharge pipe 64, and to generate a signal 70 to the controller 82. It will be understood that either of these pressure sensors will provide a signal that generally corresponds to the pressure in the separator 50. In addition, a pressure sensor 65 may be disposed on the portion of the liquid discharge pipe 66 downstream of the liquid pump 71 to generate a signal 74 to the controller 82. In addition, a pressure sensor 67 may be disposed on the liquid gathering pipe 96A to generate a signal 77 to the controller 82.

Also supported on the skid 51 along with the separator 50 is a liquid pump 71 fluidically connected to the liquid discharge pipe 66 at a pump inlet 72 and fluidically connected to a pump outlet 79. The liquid pump 71 receives oil or an oil and water mixture from the liquid discharge pipe 66 and boosts the pressure of the liquid discharged from the separator 50 through the pump 71 and into the pump discharge pipe 79 by, for example, 50 psig to 150 psig to suppress the formation of bubbles in the liquid and to thereby facilitate accurate metering of the liquid at a flow meter 78 disposed downstream of the liquid pump 71. Also supported on the skid 50 at a position downstream of the flow meter 78 is an automated liquid sampler 76. Optionally, an actuated control valve 80 may be provided on the skid 50 at a position downstream of the flow meter 78 and downstream of the automated liquid sampler 76. Optionally, the actuated control valve 80 can be located off the skid 50, for example, downstream of the liquid gathering pipe flange 96 but upstream of the pressure sensor 67.

The pump 71 is operated by an electrically-powered pump motor 73. In one embodiment of the present invention, the pump motor 73 receives a signal 85 from a controller 82 that controls the speed of the pump motor 73 and the throughput of the pump 71. Alternately, the pump motor 73 receives a signal 85 in the form of a conditioned current from a current conditioning device, such as a variable frequency drive (not shown), that, in turn, receives the signal 85 from the controller 82. The signal 85 to the pump motor 73, whether or not conditioned by a current conditioning device, corresponds to a signal 84 received by the controller 82 from the liquid/gas interface sensor 68. For example, where the liquid/gas interface sensor 68 detects an elevated liquid/gas interface (not shown) at or near the top portion of an operating range (not shown), the liquid/gas interface sensor 68 generates a signal 84 corresponding to a the elevated position of the liquid/gas interface and, in response to receiving the signal 84, the controller 82 generates a corresponding signal 85 to the pump motor 73 or, alternately, to a current conditioning device, such as a variable frequency drive, to increase the flow rate at which liquid is removed from the monitored section 53 of the separator 50 through the liquid discharge pipe 66 and the liquid pump 71. Conversely, where the liquid/gas interface sensor 68 senses that the liquid/gas interface is at or near the bottom of the operating range (not shown), the liquid/gas interface sensor 68 generates a signal 84 corresponding to a low position of the liquid/gas interface and, in response to receiving the signal 84, the controller 82 generates a corresponding signal 85 to the pump motor 73 or, alternately, to a current conditioning device, such as a variable frequency drive, to decrease the speed and the volumetric rate at which liquid is removed from the monitored section 53 of the separator 50 through the liquid discharge pipe 66 and the liquid pump 71. For embodiments having a current conditioning device, such as a variable frequency drive, to supply a conditioned current to the pump motor 73, the controller 82 would be programmed to generate a signal 85 corresponding to the flow rate at which the liquid pump 71 should operate to restore the liquid/gas interface to the desired position within the separator 50.

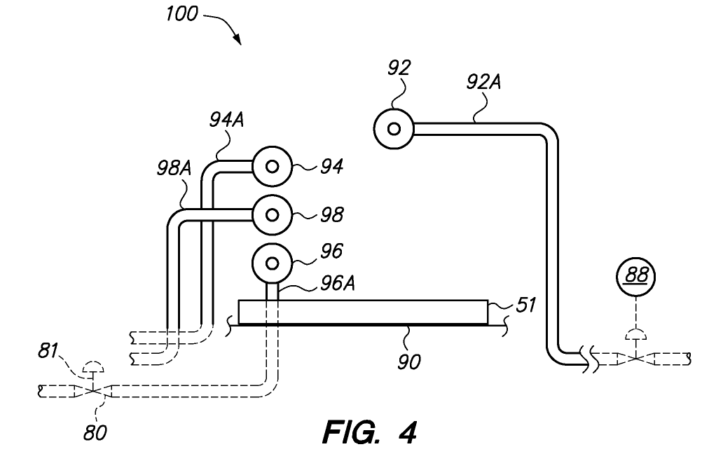

The controller 82 may, in one embodiment, be a programmable logic controller (PLC) for receiving one or more signals from and for sending one or more signals to a plurality of devices such as, for example, but not by way of limitation, receiving a signal 84 from the liquid/gas interface sensor 68, sending a signal 85 to the pump motor 73, receiving a signal (not shown) from the meter 78, sending a signal (not shown) to the automated liquid sampler 76, receiving a signal (not shown) from the oil/water interface sensor (not shown), sending a signal (not shown) to a gas discharge back-pressure valve (not shown), sending a signal 81 to a back pressure control valve 80, receiving signals 77, 86, 74, and 70 from pressure sensors 67, 62, 65 and 61, respectively, and for sending signals to and/or receiving signals from other devices and/or equipment that may be on the skid 51 or, alternately, that may be off the skid 51 such as, for example, on a docking station 100 (not shown in FIG. 3—see FIG. 4) that couples to pieces of equipment on the skid 51 or devices and/or equipment that may be distanced from hydrocarbon processing equipment for compliance with codes and standards.

The inlet flange 52, the gas discharge flange 54, the liquid discharge flange 56 and the water discharge flange 58 are, in the embodiment of the skid-mounted separator 50 of FIG. 3, disposed at a first end 51A of the skid 51 to facilitate the convenient connection of these flanges to corresponding flanges that may, in one embodiment, be provided on a docking station. A docking station (not shown in FIG. 3) facilitates the coupling of the second end of a flow line 92 to the separator inlet flange 52, the gas gathering pipe 94 to the gas discharge pipe 64, the liquid gathering pipe 96A to the liquid discharge pipe 66 (through other devices installed therein) and the water gathering pipe 98 to the water discharge flange 58, respectively. It not necessary that all flanges on the skid be co-extensive or aligned with each other for with the first end 51A of the skid 51 and, in other embodiments, one or more of the inlet flange 52, gas discharge flange 54, oil discharge flange 56 and the water discharge flange 58 may be offset (to be non-co-extensive) or positioned for engaging a corresponding pipe and flange along the front of the skid 51 that is disposed toward the viewer of FIG. 3 (instead of the end of the skid as illustrated in FIG. 3). A skid 50 can be, in some embodiments, slid or rolled into position for making connections along one, two or even three sides of the skid 51 but positioning of the skid 51 on the skid support 90 to be coupled to the docking station is made more convenient by disposing the flanges for making connections along only one end, one side, or at one end and one adjacent side of the skid 51. It will be understood that although these flanges illustrated in FIG. 3 are facing outwardly away from the skid 50, other embodiments may provide flanges facing upwardly, downwardly or even inwardly without impairment of the function of the flanges. It will be further understood that flanges are shown in FIG. 3 merely for convenience, and that other connections, such as screwed connections, are equally useful.

FIG. 4 is an elevation view of an embodiment of a docking station that can be used to connect to the skid-mounted separator 50 of FIG. 3 and related equipment of FIG. 3 to implement an embodiment of the method and system of the present invention. The embodiment of the docking station of FIG. 4 comprises the skid support 90, a flow line 92A terminating at a flow line flange 92, a liquid gathering pipe 96A terminating at a liquid gathering pipe flange 96, a gas gathering pipe 94A terminating at a gas gathering pipe flange 94, and a water gathering pipe 98 terminating at a water gathering pipe flange 98A. It should be noted that the section view line on FIG. 3 is staggered, near the bottom, to include a small part of the end portion 51A of the skid 51 and the skid support 90. It should also be noted that the configurations of the pipes and flanges on FIG. 4 is but one possible arrangement of positioning the flanges 92, 94, 96 and 98 on the docking station to engage and coupled to the corresponding flanges 52, 54, 56 and 58 supported on the skid 51 or, alternately, on the turndown skid to be discussed in more detail below.

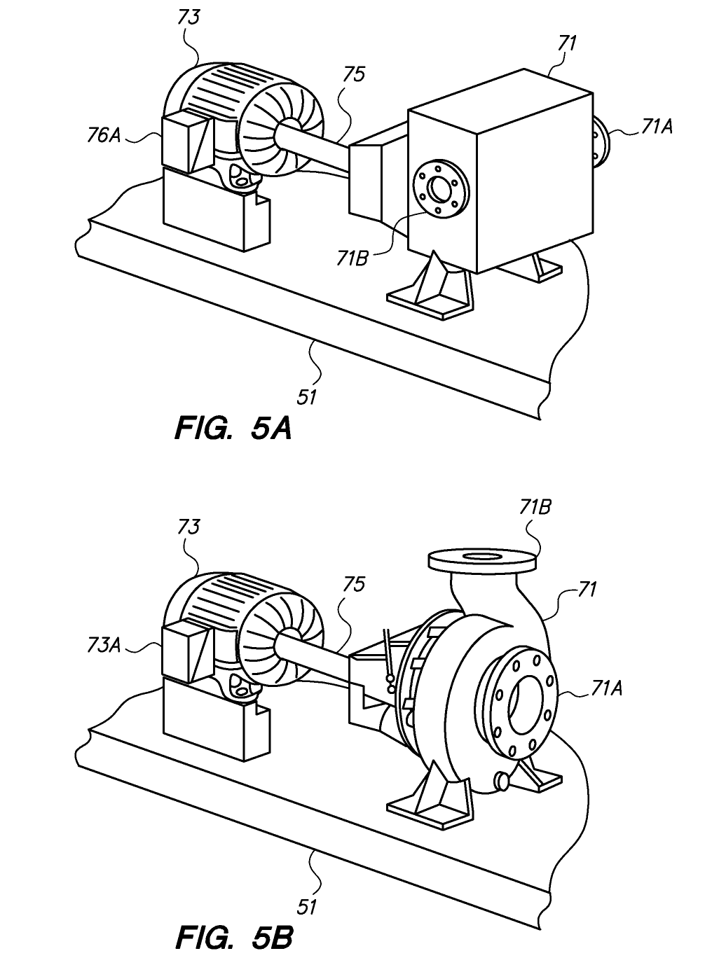

FIG. 5A is a perspective view elevation view of one embodiment of a liquid pump 71 and pump motor 73 of a kind and type that could be supported, for example, on the skid 51 of FIG. 3 and that could be used to implement various embodiments of the method and system of the present invention. The portions of the liquid discharge pipe 66 (shown in FIG. 3) are removed from both the pump suction flange 71A and the pump discharge flange 71B in FIG. 5A to better reveal the liquid pump 71, which may be, for example, a gear pump. A pump motor 73 is illustrated as being coupled to the liquid pump 71 through a rotatable shaft 75 to provide power to the internal pump components (not shown) to move and pressurize the liquid (not shown) entering the pump suction flange 71A from the pump feed section 53 (see FIG. 3) of the separator 50 (see FIG. 3).

Using a gear pump for the liquid pump 71 may provide the advantages of an available high pressure differential across the liquid pump 71 and a broad turndown range. These features may provide great flexibility to the system and method. The example of the liquid pump 71 illustrated in FIG. 5A is but one of many pump and motor combinations that may be used to implement the method and system of the present invention. For example, but not by way of limitation, FIG. 5B illustrates an alternate embodiment of the liquid pump 71 and pump motor 73 wherein the liquid pump 71 is a centrifugal pump.

FIGS. 5A and 5B illustrate embodiments of pump and motor combinations that could be used in embodiments of the method and system of the present invention. In an alternative embodiment, the liquid pump and pump motor may comprise a pump assembly having a motor, a pump, non-magnetic case or a non-magnetic case portion of a non-magnetic material such as, for example, stainless steel, high-strength plastic or carbon composite, to facilitate the magnetic transfer of torque from an output shaft of a the motor, such as an electrically-powered motor, to the internal rotating element of the pump using a magnetic coupling. A magnetic coupling uses a plurality of leader magnets coupled to the pump motor output shaft for rotation about an axis of the shaft and in close proximity to a plurality of corresponding follower magnets coupled to the pump input shaft, impeller shaft, etc. to magnetically transfer torque from the shaft of the output pump motor to the input shaft of the pump. The leader magnets on the pump motor output shaft and the follower magnets on the liquid pump input shaft may be strategically oriented to present compatible polarity and to promote optimal attraction and optimal torque transfer from the pump motor to the pump. The use of a magnetic coupling in this manner eliminates the need for the use of seals to contain and isolate the high-pressure liquid stream within the pump.

The gear pump of FIG. 5A provides operational advantages over other pumps such as, for example, the centrifugal pump of FIG. 5B. For example, the purpose of the liquid pump is to enable and provide control of the rate at which liquid is removed from the monitored section of the separator, and the throughput of a gear pump is primarily determined by the speed and is generally immune to the discharge pressure. Some embodiments of the method and system of the present invention include providing a back pressure control valve downstream of the liquid pump so that the liquid meter is intermediate the liquid pump and the back pressure control valve. In these embodiments, the back pressure control valve may be used to control the pressure of the liquid stream at the liquid meter and at any automated liquid sampler or densitometer that may be provided intermediate the liquid pump and the back pressure control valve to ensure that the pressure at which metering and sampling occurs is above the bubble point of the liquid stream removed from the separator. This combination of a positive displacement pump, capable of being operated at varying speeds to provide control of the rate of removal of liquid from the monitored section of the separator, and a back pressure control valve positioned downstream of the liquid meter, enables favorable control of the liquid/gas interface within the monitored section of the separator and, at the same time, favorable maintenance of the pressure at the liquid meter above the bubble point.

The motor used to operate the liquid pump may be electrically-powered and, more specifically, may be either direct current (DC) or alternating current (AC). In an embodiment of the method and system of the present invention in which the motor is a DC motor, the DC motor may be a servo-motor and the DC current may be provided to the motor by a bank of batteries that are periodically rechargeable using, for example, solar panels, where climate is favorable, or using a diesel, gasoline or produced hydrocarbon gas-powered generator. The controller may be used to monitor the status of the batteries and to manage the recharging of the batteries.

In an embodiment of the method and system of the present invention in which the motor is an AC motor, the current may be provided by a lateral from an electric power distribution grid. It will be further understood that such DC or AC sources may further be used to power chemical injection pump motors, to operate operating feedback and control systems, actuated valves and communications systems for communicating status and alerts to remotely monitored systems. For AC pump motor embodiments, the frequency of the alternating current may be directed by the controller in response to the signal from the liquid/gas interface sensor, and a variable frequency drive (VFD) may be provided at the well location, but distanced from the separator and other hydrocarbon processing equipment according to codes and rules, to receive and condition AC power from a power distribution grid in accordance with the requirements as instructed by the controller.

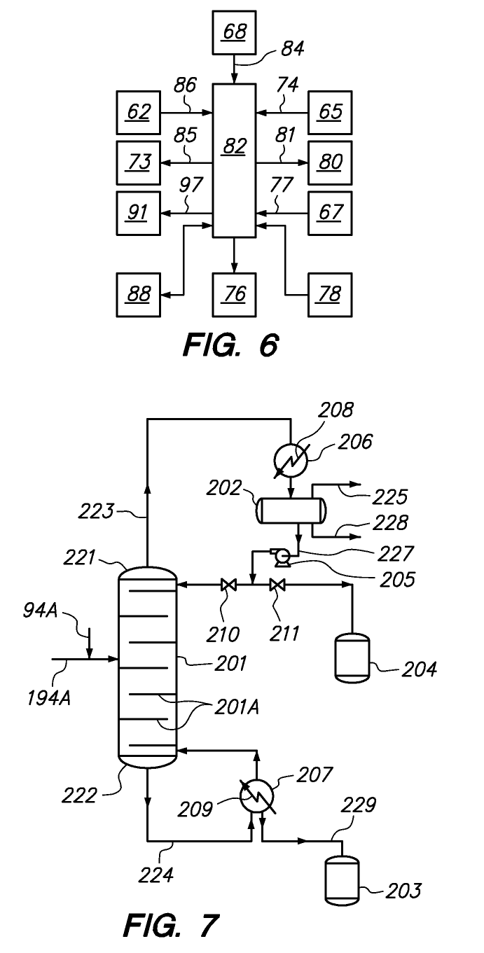

FIG. 6 is a schematic illustrating the input and/or output connections of a controller 82 electronically coupled to the pump motor 73, an automated liquid sampler 76, a gas/liquid interface sensor 68, a flow meter 78, a liquid back pressure control valve 80, an emergency shut-down (ESD) system 88, a first pressure sensor 62, a second pressure sensor 65, a third pressure sensor 67, and a chemical injection pump motor 91. It should be understood that some of these and other devices may be used to generate input signals to the controller 82 such as, for example, but not by way of limitation, a pressure sensors 62, 65 and 67 to generate signals 86, 74 and 77 corresponding to the sensed pressures in the liquid discharge pipe 66 (shown in FIG. 3) just removed from the separator 50 (which is approximately the separator pressure), the portion of the liquid discharge pipe 66 (shown in FIG. 3) downstream of the pump 71 (shown in FIG. 3) but upstream of the back pressure control valve 80 (shown in FIG. 3), and the liquid gathering pipe 96A (shown in FIG. 3) downstream of the back pressure control valve 80 (shown in FIG. 3), respectively. Additionally, an oil/water interface sensor (not shown in FIG. 3) may generate a signal corresponding to the position of the oil/water interface in a water section of the separator, a water dump valve (not shown) may receive a signal generated by the controller 82 to open or close to adjust the position of the oil/water interface in the separator. It will be understood that the ESD system 88 may, in one embodiment, be in pneumatic or electronic communication with, for example, an ESD valve (not shown) at a wellhead (which may be referred to as the first end of the flow line (see element 92A on FIG. 3, which is the second end of the flow line) that can be actuated to close in the event of, for example, an excessively high oil/water interface in the separator, an excessively high or low liquid/gas interface in the separator, an excessively high or low separator pressure, a failure or impairment of the liquid pump, or other conditions that may warrant a shut-in of the well and/or the equipment on the skid.

The controller 82 may, in one embodiment, be a single controller or, in other embodiments, two or more controllers programmed to cooperate with one or more others to accomplish the objectives for which they are programmed. It will be understood that the controller 82 is illustrated to be in more than one location on FIG. 3 merely for purposes of convenience of illustration, and that an actual controller may be a single device located in a single location and connected to numerous devices. It should be further understood that a controller may be connected wirelessly, by electrically conductive wires, by optically conductive fibers, pneumatic conduits, and by other means known in the art for transmitting signals from one device to another.

FIG. 7 is a side elevation view of an embodiment of a liquid stabilizer tower 201 that may be used at a central conditioning facility fed by the liquid stream discharged from the separator 50 through the liquid discharge pipe 66 and to the liquid gathering pipe 96A (see FIG. 3), and by commingled or isolated liquid streams received into the central conditioning facility from other separators at other well locations, all aggregated together to form a liquid stream 194A entering the stabilizer tower 201 in FIG. 7. In one embodiment, the stabilizer tower 201 comprises a plurality of trays 201A, spaced apart one from the others and arranged in a generally vertical stack to facilitate the establishment of a tray-by-tray equilibrium in which lighter hydrocarbon components in the liquid such as, for example, propane and butane, evaporate and rise from a given tray and move through valves or openings in the adjacent tray above, while heavier hydrocarbon components such as, for example, pentane and hexane, remain in liquid form and descend from a given tray through down-comers located in or adjacent to the tray and to the tray therebelow.

A reboiler 207 may be disposed to receive the stream 224 of heavier (liquid) hydrocarbon components of the liquid stream discharged from the bottom section 222 of the stabilizer tower 201. The reboiler 207 may comprise a shell and tube heat exchanger in which heat from a heat source 209, such as steam or heat medium oil, is imparted to the stream 224 from the bottom section 222 to evaporate some of the lighter hydrocarbon components of the liquid stream to maintain tower dynamics. The reboiler 207 may be equipped with a rundown line 229 through which liquid having an adjusted vapor pressure may feed to a receiving and/or storage vessel, such as a stock tank or pipeline pump suction tank 203. A condenser 208 may be disposed to receive the stream 223 of lighter (gaseous) components of the liquid (primarily hydrocarbons) discharged from the top section 221 of the stabilizer tower 201. The condenser 208 may also comprise a shell and tube heat exchanger in which heat from the gas stream 223 discharged from the top section 221 of the stabilizer tower 201 can be removed to or sunk into a stream of a cooler medium 206 such as, for example, ambient or chilled water. In other embodiments, an aerial cooler may be used to remove heat from the gas stream 223 and/or a waste heat source from another system, such as, for example, combustion products, may be used to heat the liquid stream 224. A reflux drum 202 may be used to receive the cooled hydrocarbon stream from the condenser 206 to separate the stream into a gas stream 225 (primarily ethane and propane), a waste water stream 228 and a condensed liquid stream 227 that is returned to the stabilizer tower 201 as reflux through valve 210 or, alternately, it can be routed through valve 211 to a receiver 204 or other storage vessel.

Where the commingled streams of liquid to be fed into the stabilizer tower of FIG. 7 comprises a mixture of liquid hydrocarbons (oil or condensate) and water, it is advantageous to separate the liquid hydrocarbon component from the water prior to feeding the liquid hydrocarbon component into the stabilizer tower. Where the separator at the well location (for example, the separator 50 in FIG. 3) is a two-phase separator, the removal of water from the commingled liquid stream prior to introducing of the commingled liquid stream into the stabilizer tower may be required for favorable stabilizer performance. Where the separator at the well location is a three-phase separator, which separates water from a liquid hydrocarbon stream, the separation step prior to introducing the commingled liquid stream into the stabilizer at the central conditioning facility may be unnecessary.

A stabilizer tower 201 can provide for removal of unwanted lighter hydrocarbon components from the commingled liquid stream to a gas phase so that the lighter hydrocarbon components may be advantageously removed from the stabilizer tower 201 top section 221 while retaining the heavier hydrocarbon components in the liquid phase that is removed from the stabilizer tower 201 at the bottom section 222. In this manner, an aggregate liquid stream 194A comprising the liquid streams removed from separators at a plurality of contributing wells (96A and others) may be economically conditioned at the central conditioning facility illustrated in FIG. 7 to provide a favorable vapor pressure of the liquid stream to avoid deductions from the sale price by a purchaser. The removed propane or other lighter hydrocarbon components may be transported to market from the central conditioning facility via mobile transport, such as a truck.

It should be understood that embodiments of the method and system of the present invention may be used without a central conditioning facility, and that the conditioning of the commingled liquid stream from multiple wells does not necessarily require a stabilizer with a reboiler and a reflux system. Instead, the commingled liquid stream may be conditioned by receiving the commingled stream into a slugcatcher, bullet or separator, but these options do not provide the same capacity to selectively remove the lighter hydrocarbons and to thereby condition the liquid for favorable pricing.

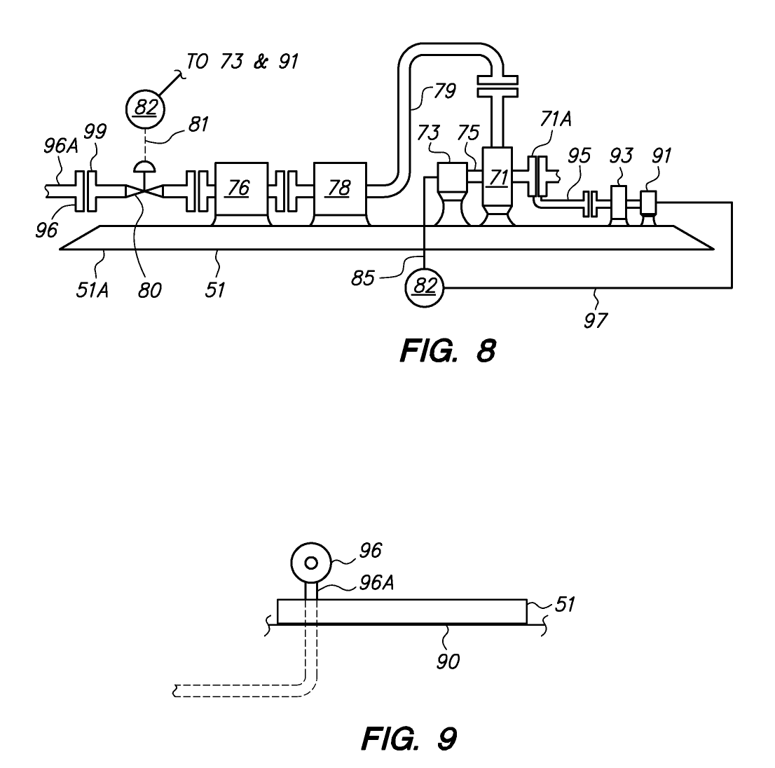

FIG. 8 is a side elevation view of an embodiment of a second, alternate skid 51 supporting a liquid pump 71, a pump motor 73, a flow meter 78, an automated liquid sampler 76, a chemical injection pump 93 and a chemical injection pump motor 91. The second, alternate skid 51 illustrated in FIG. 8 may be connected to a separator (not shown) supported off the skid. A connecting pipe may be fabricated to facilitate providing a liquid stream from a separator liquid discharge flange (not shown in FIG. 8) on, for example, a two-phase or three-phase separator located off-skid, to the pump suction flange 71A or other type of (e.g., screwed) connection to the pump inlet. The second skid 51 and the equipment thereon in FIG. 8 may be used to implement the method and system of the present invention using an existing separator at a well location or, optionally, using a separator on an adjacent skid. This alternate method and system permits the use of a smaller skid 51 as compared to the skid that would be required to support these same pieces of equipment along with a separator, and the embodiment illustrated in FIG. 8 enables cost reduction through the continued use of an existing separator and related gas discharge and water discharge pipes, valves, instrumentation and hardware.

The chemical injection system comprising the chemical injection pump 93, the chemical injection pump motor 91 and a container of chemical to be injected (not shown), for example, but not by way of limitation, a barrel or drum of scale inhibitor, corrosion inhibitor, paraffin inhibitor, emulsion breaker or friction reducing agent, can be disposed on the skid 51 or off-skid and connected to an inlet (not shown) on the chemical injection pump 93 and pressurized chemical is injected by way of chemical pump discharge conduit 95 at, for example, the inlet flange 71A of the liquid pump 71. The rate at which the chemical pump 93 operates and the corresponding concentration of the chemical in the liquid flow stream through the liquid pump 71, the automated oil sampler 76, the flow meter 78, the back pressure control valve 80 and the liquid gathering pipe 96A is controlled using the controller 82. The controller 82 generates a signal 97 to the chemical injection pump 91 corresponding to the signal 85 (not shown—see FIG. 6 and FIG. 3) to the liquid pump motor 73. It will be understood that the controller 82 may generate a signal to the chemical injection pump motor 91 corresponding to the signal 85 generated by the controller 82 to the liquid pump motor 73 because the two should operate in harmony to ensure that the concentration of the chemical in the liquid flow stream removed from the separator is as prescribed by the chemical manufacturer or otherwise in a concentration that is effective for the intended purpose. It will be further understood that this method of controlling the rate at which chemical agents are injected into the liquid flow stream being removed from the separator conserves expensive chemicals by preventing injection rates above an effective concentration. Alternatively, the chemical may be set to inject proportional to the mass or volumetric flow of the liquid.

FIG. 9 is an elevation view of an embodiment of a docking station that may be used to couple to the equipment supported on the second, alternate skid of FIG. 8 that may be used to implement an alternate embodiment the method and system of the present invention. The docking station of FIG. 9 comprises a skid support 90 positioned to support the skid 51 of FIG. 8 in a position to facilitate the connection of the liquid gathering pipe 96A and the related flange 96 of FIG. 8 to the liquid pipe discharge flange 99 on the skid 51 on FIG. 8. The optional actuated control valve 80 may be used to control the pressure of liquid stream discharged from the skid 51 to the liquid gathering pipe 96A. The actuated control valve 80 may be controllable by way of a signal 81 from the controller 82. The actuated control valve 80 may be, in other embodiments, located off-skid. The speed and throughput of the pump 71 may also be controllable by the controller 82 sending a signal 85 to the pump motor 73.

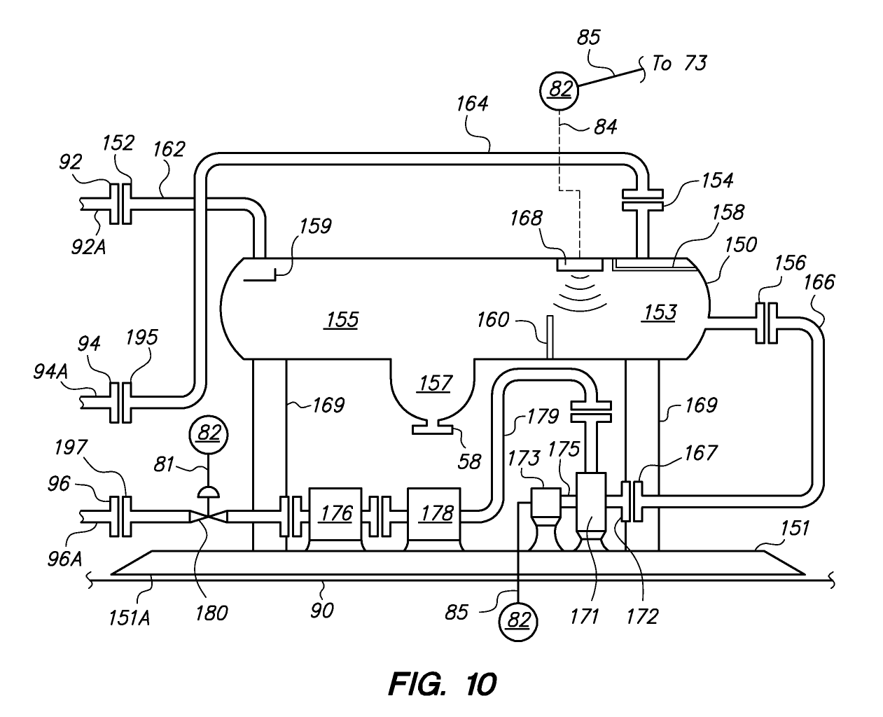

FIG. 10 is a side elevation view of an embodiment of a second, turndown skid 151 supporting a second, smaller separator 150 and related equipment supported on a skid support 90 to facilitate docking of the second skid 151 and the separator 150 supported thereon with a docking station, such as that illustrated in FIG. 4. The embodiment of the second skid 151 illustrated in FIG. 10 comprises a first end 151A at which inlet flange 152, gas discharge pipe flange 195 and liquid discharge pipe flange 197 are conveniently positioned to be coupled to a flange 92 on the second end of a flow line 92A, a flange 94 on the gas gathering pipe 94A and a flange 96 on the liquid gathering pipe 96A, respectively. The smaller separator 150 illustrated in FIG. 10 comprises a mist eliminator 158, a weir 160, a gas discharge flange 154, a liquid discharge flange 156 and a pair of separator supports 169 spaced one from the other to support the separator 150 at a spaced distance from the second skid 151. The second skid 151 further supports a liquid pump 171 coupled to be operated by a pump motor 173 adjacent thereto, an automated liquid sampler 176, a liquid flow meter 178 positioned downstream of the liquid pump 171, and an optional control valve 180. A liquid/gas interface sensor 168 such as, for example, a guided wave radar sensor, generates a signal 84 corresponding to the detected liquid/gas interface (not shown) within the second separator 150 to a controller 82 that, in turn, generates a signal 85 to the pump motor 173 to speed up or slow down the liquid pump 171 to maintain the volume of liquid in the monitored section 153 of the second separator 150 within a desired operating range.

The second separator 150 on the second skid 151 illustrated in FIG. 10 may be substantially smaller than the first separator 50 on the first skid 51 in FIG. 3, and the second separator 150 may have a substantially smaller throughput capacity than the first separator 50. The related piping and equipment on the second skid 151 may also be smaller in size and capacity as compared to the comparable structures illustrated in FIG. 3. For efficiency and interchangeability, the size of the various flanges and connections used on the liquid pump 171, the pump motor 173, the liquid flow meter 178, and the automated liquid sampler 176 may be maintained from the first skid 51 to the second skid 151, and that concentric and/or eccentric reducers and similar pipe fittings (not shown in FIG. 10) may be employed to accommodate smaller piping for lower flow rates such as, for example, the gas discharge pipe 164 in FIG. 10. Additionally, the turndown skid may have differently sized pumps, piping and flow meter. To promote efficiency and to expedite skid replacement and turndown of the production facility, it is advantageous if connecting flanges 197 (to liquid gathering line), 195 (to gas gathering line) and 152 (separator inlet line), and perhaps a connecting flange on the water pipe, be of the same size and pressure rating for both the turndown skid (e.g., of FIG. 10) and the first skid (e.g., of FIG. 3).

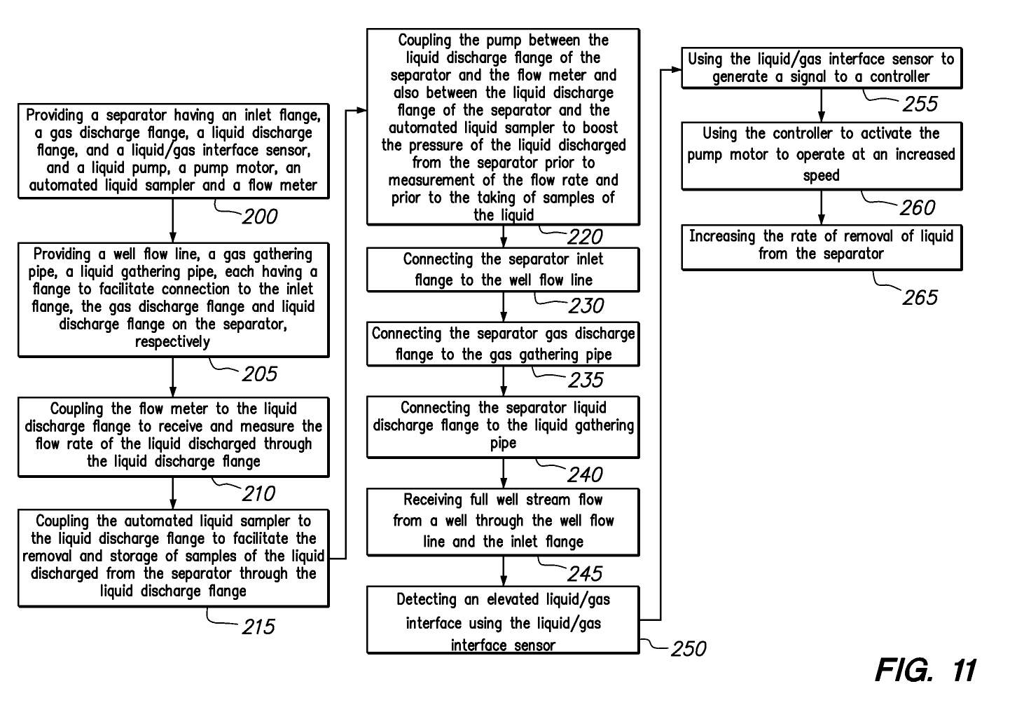

FIG. 11 is a high-level flow chart illustrating an embodiment of a method for metering liquids produced from a well using the methods and systems of the present invention. Steps 200 through 265 illustrate one embodiment of implementing the method of the present invention to produce a well. In step 200, a first separator having an inlet flange, a gas discharge flange, liquids discharge flange, a liquid/gas interface sensor and a liquids flow meter is provided. In step 205, a docking station comprising a flow line, a gas gathering pipe, and a liquid gathering pipe to facilitate connections to the inlet flange, the gas discharge flange and the liquid discharge flange is provided. In step 210, the liquids flow meter is connected to the oil discharge flange of the separator and, in step 215, the automated liquid sampler is connected to the oil discharge flange of the separator. In step 220, a liquid pump is connected intermediate the liquid discharge flange of the separator and both the automated liquid sampler and the liquid flow meter to vary the flow rate of liquid from the separator and through the automated liquid sampler and the liquid flow meter to facilitate control of the liquid/gas interface in the monitored section of the separator while providing additional pressure boost to ensure that the liquid being metered and sampled in the liquid flow meter and the automated liquid sampler is above the bubble point of the liquid. In step 230, the separator inlet flange is connected to the flow line, in step 235, the separator gas discharge pipe is connected to the gas gathering pipe and, in step 240, the separator liquid discharge flange is connected to the liquid gathering pipe. In step 245, full well stream production from a well is received through the flow line and the inlet flange and into the separator. In step 250, an elevated liquid/gas interface is detected using the liquid/gas interface sensor on the separator. In step 255, the liquid/gas interface sensor is used to generate a signal to a controller. In step 260, the controller is used to activate the pump motor to operate at an increased speed and, in step 265, the increased speed of the pump motor results in an increase in the rate of removal of liquid from the section of the separator that is monitored by the liquid/gas interface sensor. In a subsequent step not illustrated in FIG. 11, the liquid/gas interface sensor senses a corrected position of the liquid/gas interface in the monitored section of the separator and the liquid/gas interface sensor generates a signal to the pump motor to slow the speed of the pump to thereby decrease the rate of removal of liquid from the monitored section of the separator. It will be understood that, by continuing to use the liquid/gas interface sensor to control the speed of the pump motor and the throughput of the pump, the liquid/gas interface in the monitored section of the separator can be maintained within a desired operating range while maintaining the pressure of the liquid stream flowing through the liquid flow meter and the automated liquid sampler above the bubble point.

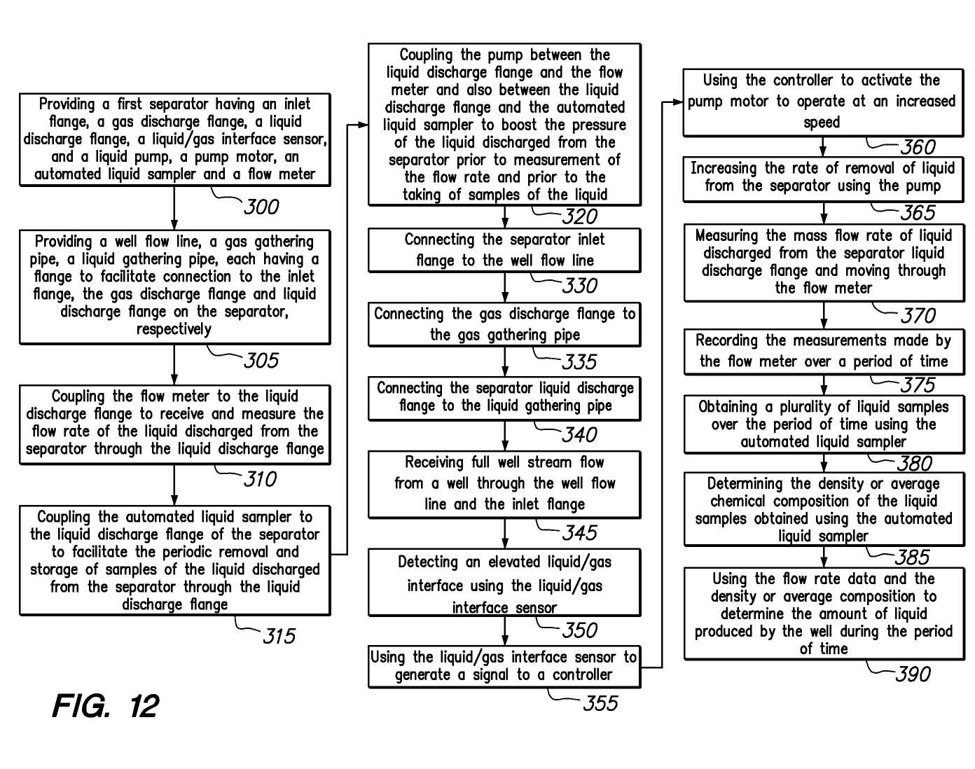

FIG. 12 is a flow chart illustrating the steps of an embodiment of a method for determining the hydrocarbon production for a well by metering at the well surface location in accordance with the present invention. In step 300, a first separator having an inlet flange, a gas discharge flange, a liquid discharge flange, a liquid/gas interface sensor, a pump, a pump motor and an automated liquid sampler is provided. In step 305, a well flow line, a gas gathering pipe, and a liquid gathering pipe, each having a flange to facilitate connection to the inlet flange, the gas discharge flange and the liquid discharge flange are provided. In step 310, a liquid flow meter is coupled to the discharge flange of the separator to meter the flow rate of the liquid discharged from the separator through the liquid discharge flange. In step 315, an automated liquid sampler is coupled to the discharge flange of the separator to facilitate the periodic removal and storage of samples of the liquid stream discharged from the separator through the liquid discharge flange. In step 320, a pump is coupled intermediate the liquid discharge flange of the separator and both of the liquid flow meter and the automated liquid sampler to facilitate control of the liquid/gas interface in the monitored section of the separator while providing additional pressure boost to ensure that the liquid being metered and sampled in the liquid flow meter and the automated liquid sampler is above the bubble point of the liquid. In step 330, the separator inlet flange is connected to the flow line from the well. In step 335, the gas discharge flange is coupled to the gas gathering pipe and, in step 340, the liquid discharge flange is coupled to the liquid gathering pipe (through the pump, the liquid flow meter and the automated liquid sampler). In step 345, full well stream is received from a well through the flow line and the inlet flange and into the separator. In step 350, an elevated liquid/gas interface is detected in the monitored section of the separator using the liquid/gas interface sensor. In step 355, the liquid/gas interface sensor is used to generate a signal to a controller and, in step 360, the controller is used to activate the pump motor to operate at an increased speed to, in step 365, increase the rate of removal of liquid from the monitored section of the separator. In step 370, the flow rate of liquid removed from the monitored section of the separator through the liquid discharge flange is measured using the flow meter and, in step 375, the measurements of the liquid flow rate through the meter over a period of time are recorded. In step 380, a plurality of liquid samples are obtained and stored using the automated liquid sampler and, in step 385, an average chemical composition of the liquid samples obtained using the automated liquid sampler is obtained by, for example, using chromatographic analyses performed in a laboratory to determine a distribution of hydrocarbon molecules in a composite of the accumulated and stored samples. Finally, in step 390, the recorded liquid flow rate data and the chemical composition data obtained in step 385 are together used to determine the amount of liquid and, more specifically, the amount of the various hydrocarbons produced by the well during the period of time. In a subsequent step, not illustrated in FIG. 12, the royalties due to a mineral interest owner in the well are calculated using the recorded liquid flow rate data and the chemical composition data obtained in step 385 are determined and paid by the well operator.

The term “liquid,” as that term is used herein, may refer to oil, condensate, an oil and water mixture, a condensate and water mixture, and/or to other mixtures comprising at least one hydrocarbon liquid. The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. A method of controlling an interface in a separator section while metering liquid removed from the separator section comprising:
providing a first pressure sensor in a separator to generate a signal to a controller;
providing a liquid pump having an inlet coupled to receive a liquid flow stream through a liquid discharge connection on the separator;
providing a back pressure control valve positionable to choke the liquid flow stream discharged from an outlet on the liquid pump;
providing a liquid flow meter intermediate the outlet of the liquid pump and the back pressure control valve;
providing an actuator to receive a signal from the controller and to position the back pressure control valve to maintain a minimum pressure on the liquid flow stream adjacent to the liquid meter at a pressure equal to or greater than a predetermined amount above a separator pressure detected by the first pressure sensor;
providing a second pressure sensor to detect the pressure of the liquid flow stream intermediate the outlet on the liquid pump and the back pressure control valve;
coupling an electrically-powered motor to operate the liquid pump;
disposing a liquid/gas interface sensor proximal a liquid section of the separator;
generating a signal to the controller using the liquid/gas interface sensor corresponding to an elevated position of a liquid/gas interface in a monitored section of the separator adjacent the liquid discharge connection;
generating a signal using the controller to condition an electrical current flow to the motor to accelerate a rate at which the liquid flow stream is removed from the monitored section of the separator through the pump;
generating a signal using the controller to re-condition the electrical current flow to the motor to reduce the rate at which the liquid flow stream is removed from the monitored section of the separator through the pump;
using the liquid meter to measure the rate at which the liquid flow stream is removed from the monitored section of the separator and to generate a plurality of signals to the controller corresponding to a plurality of measurements; and
using the plurality of measurements made within a given time period to determine the amount of liquid removed from the separator through the liquid pump and the back pressure control valve.

2. The method of claim 1 wherein the electric motor is powered by an alternating current; and
generating a signal using the controller to condition an electrical current flow to the motor to accelerate a rate at which the liquid flow stream is removed from the monitored section of the separator through the pump comprises:
generating a signal using the controller to a variable frequency drive unit receiving current from a power distribution lateral;
wherein the current is conditioned by manipulation of the frequency.

3. The method of claim 1 wherein the liquid removed from the monitored section of the separator comprises oil.

4. The method of claim 1 wherein the liquid meter comprises a Coriolis mass flow meter.

5. The method of claim 1 wherein the liquid meter comprises a volumetric flow meter.

6. The method of claim 1 further comprising:
providing an automated liquid sampler intermediate the outlet of the liquid pump and the back pressure control valve to obtain and store a plurality of samples of the liquid flow stream.

7. The method of claim 6 further comprising:
using the controller to generate a signal to activate the automated liquid sampler to obtain a sample;
wherein the controller generates a signal to activate the automated liquid sampler to obtain a sample based using a frequency dependent upon the rate at which the liquid is removed from the monitored section of the separator.

8. The method of claim 1 further comprising:
providing a supply of a chemical;
providing a chemical pump operated by an electric motor, the chemical pump configured to inject chemical into the liquid flow stream removed from the separator;
generating a signal to the electric motor to operate the chemical pump at a speed that corresponds to a targeted chemical injection rate proportional to the rate at which liquid is removed from the separator.

9. The method of claim 8 wherein the chemical is one of a scale inhibitor, an oxygen scavenger, a corrosion inhibitor, a paraffin inhibitor and friction reducer.

10. A method of controlling the position of a liquid/gas interface a separator comprising:
disposing a liquid/gas interface sensor proximal a section of the separator to monitor a position of a liquid/gas interface therein;
detecting with the liquid/gas interface sensor an elevated position of the liquid/gas interface;
generating with the liquid/gas interface sensor a signal corresponding to the elevated position of the liquid/gas interface to a controller;
generating with the controller a signal to a current conditioning device coupled to a current source;
using the current conditioning device to condition a current from the current source to an electric motor coupled to operate a pump, having an inlet to receive a liquid flow stream from the monitored section of the separator and an outlet to discharge the liquid stream from the pump, at an accelerated speed to increase the rate of removal of liquid from the monitored section of the separator in response to the detected elevated position of the liquid/gas interface;
providing a liquid stream flow meter to measure the flow rate of the liquid flow stream from the outlet of the pump;
storing with the controller data corresponding to flow rates of the liquid flow stream measured using the liquid stream flow meter;
providing a back pressure control valve intermediate the liquid meter and a liquid gathering pipe, the back pressure control valve having an actuator thereon to position the back pressure control valve in response to a signal from the controller;
providing a first pressure sensor to detect a pressure in the separator and a second pressure sensor to detect the pressure in the liquid gathering pipe intermediate the pump and the back pressure control valve;
generating with the first pressure sensor a signal to the controller corresponding to the detected pressure in the separator;
generating with the second pressure sensor a signal to the controller corresponding to the detected pressure in the liquid gathering pipe intermediate the pump and the back pressure control valve; and
generating a signal with the controller to the actuator to position the back pressure control valve to maintain the pressure of the liquid flow stream at the liquid meter at a pressure greater than the detected separator pressure.

11. The method of claim 10 wherein the pump comprises a gear pump.

12. The method of claim 10 wherein the liquid flow meter comprises a Coriolis mass flow meter.

13. The method of claim 11 wherein the liquid flow meter comprises a Coriolis mass flow meter.

14. The method of claim 10 wherein the liquid flow meter comprises a volumetric flow meter.

15. The method of claim 14 wherein the liquid flow meter comprises a turbine meter.

16. The method of claim 11 wherein the liquid flow meter comprises volumetric flow meter.

17. The method of claim 1 further comprising:
detecting with the liquid/gas interface sensor a corrected position of the liquid/gas interface;
generating with the liquid/gas interface sensor a signal corresponding to the corrected position of the liquid/gas interface to the controller;
generating with the controller a signal to the current conditioning device coupled to the current source;
using the current conditioning device to condition a current from the current source to the electric motor coupled to operate a pump at a reduced speed, relative to the accelerated speed, to decrease the rate of removal of liquid from the monitored section of the separator in response to the detected corrected position of the liquid/gas interface.

18. A method of measuring liquid hydrocarbons produced by a well comprising:
providing a well coupled to a first end of a flow line;
providing a separator having an inlet coupled to a second end of the flow line, a liquid discharge connection and an interface sensor to generate a signal to a controller corresponding to the position of a liquid/gas interface in the separator;
providing a pump coupled to a variable speed motor that receives a signal from the controller;
coupling the liquid discharge connection to an inlet of the pump;
coupling an outlet of the pump to a liquid gathering pipe;
providing a pressure sensor to generate a signal to the controller corresponding to a pressure in the liquid gathering pipe intermediate the pump and the liquid gathering pipe;
providing a back pressure control valve, intermediate the pump and the liquid gathering pipe, that receives a signal from the controller;
providing a liquid flow meter intermediate the outlet of the pump and the back pressure control valve to measure the amount of liquid flowing from the separator;
receiving at the controller a signal corresponding to an elevated position of a liquid/gas interface;
generating a signal from the controller to the pump motor to increase the speed of the motor and the pump coupled thereto to increase the rate at which liquid flows from the separator through the liquid discharge connection and through the pump;
receiving at the controller a signal corresponding to a corrected position of the liquid/gas interface; and
adjusting the back pressure control valve towards a closed position in response to sensing a pressure in the liquid gathering pipe that is less than a set point pressure that is equal to a predetermined pressure interval plus the vapor pressure of the liquid to maintain the pressure of the liquid in the liquid meter above the vapor pressure of the liquid;
wherein the adjusting of the back pressure control valve in the manner stated maintains the liquid in the portion of the liquid discharge pipe at a pressure sufficient to suppress the formation of bubbles to facilitate accurate measurement of the liquid removed from the separator.

19. The method of claim 18 wherein the liquid meter comprises at least one of:
a turbine meter to measure volumetric flow;
a positive displacement meter to measure volumetric flow; and
a Coriolis meter to measure mass flow.

20. The method of claim 18 further comprising:
providing a liquid sampler intermediate the outlet of the pump and the back pressure control valve to periodically obtain and store discrete samples of the liquid stream flowing through the liquid meter;
wherein the adjustment of the back pressure control valve towards a closed position in response to sensing a pressure in the liquid gathering pipe that is less than the vapor pressure of the liquid maintains the pressure of the liquid in the liquid sampler above the vapor pressure of the liquid.

21. The method of claim 18 wherein the liquid meter, the pump and the pump motor are supported on a skid.

22. The method of claim 21 wherein the separator is supported on the skid.

23. The method of claim 21 further comprising:
disposing a portion of the liquid gathering pipe adjacent to a skid support; and
positioning the skid on the skid support.

24. The method of claim 22 further comprising:
disposing a portion of the liquid gathering pipe adjacent to a skid support;
disposing the second end of the flow line adjacent to the skid support;
positioning the skid on the skid support.

25. The method of claim 19 further comprising:
providing a densitometer intermediate the outlet of the pump and the back pressure control valve; and
wherein the a liquid meter is a turbine meter.

26. The method of claim 19 further comprising:
providing a densitometer intermediate the outlet of the pump and the back pressure control valve; and
wherein the liquid meter is a positive displacement meter to measure volumetric flow.

27. The method of claim 19 further comprising:
providing a liquid sampler intermediate the outlet of the pump and the back pressure control valve to periodically obtain and store discrete samples of the liquid stream flowing through the liquid meter; and
wherein the liquid meter is a Coriolis mass flow meter.

28. The method of claim 18 further comprising:
wherein the controller is a distributed controller comprising two or more separated controllers networked to perform a coordinated function.

29. The method of claim 18 further comprising:
providing a first connection and a second connection on piping intermediate the outlet of the pump and the liquid gathering pipe to facilitate the coupling of a meter to prove the accuracy of measurements obtained using the liquid meter.

30. The method of claim 18 further comprising:
providing a second pump, fluidically disposed in parallel with the first pump, and coupled to a second pump motor; and
operating the second pump to facilitate the removal of liquid from the separator at rates above the capacity of the first pump.

31. A method for controlling the liquid/gas interface in a separator comprising the steps of:
supporting a first separator with a first skid, the separator having at least an inlet flange, a gas discharge flange, a liquid discharge flange, and a liquid/gas interface sensor, and the skid further supporting an liquid pressure boost pump, a pump motor, an automated liquid sampler and a flow meter;
providing a docking station comprising a well flow line pipe, a gas gathering pipe, an oil gathering pipe, each having a flange to facilitate connection to the inlet flange, the gas discharge flange and the oil discharge flange on the skid-supported separator;
coupling the flow meter to the liquid discharge flange of the separator to receive and measure the mass flow rate of the liquid discharged from the separator through the liquid discharge flange;
coupling the automated liquid sampler to the liquid discharge flange of the separator to facilitate the periodic removal and storage of samples of the liquid discharged from the separator through the liquid discharge flange;
coupling the liquid pressure boost pump between the liquid discharge flange of the separator and the flow meter and also between the liquid discharge flange of the separator and the automated liquid sampler to boost the pressure of the liquid discharged from the separator prior to measurement of the flow rate and prior to the taking of samples of the liquid;
positioning the skid on a skid support adjacent to the docking station;
connecting the separator inlet flange to the well flow line pipe;
connecting the separator gas discharge flange to the gas gathering pipe;
connecting the separator liquid discharge flange to the liquid gathering pipe;
receiving full well stream flow from a well through the well flow line pipe and the inlet flange;
detecting an excessively elevated liquid/gas interface using the liquid/gas interface sensor;
using the liquid/gas interface sensor to generate a signal to a controller;
using the controller to generate a signal to a variable frequency drive;
using a pump motor to operate the liquid pump at an increased speed based on the conditioned current sent by the variable frequency drive; and
increasing the rate of removal of liquid from the separator through the liquid pump.

32. The method of claim 31 further comprising the steps:
measuring the flow rate of liquid discharged from the separator liquid discharge flange and moving through the flow meter;
recording the measurements made by the flow meter over a period of time;
obtaining a plurality of liquid samples over the period of time using the automated liquid sampler;
determining the average chemical composition of the liquid samples obtained using the automated liquid sampler; and
using the mass flow rate data and data obtained from analysis of the liquid samples to determine the amount of and composition of the liquid produced by the well during the period of time.

33. The method of claim 31 wherein the pump motor is powered by a variable frequency drive.

34. The method of claim 31 wherein the pump motor is an electrically powered motor.

35. The method of claim 31 wherein the liquid pressure boost pump is a centrifugal pump.

36. The method of claim 31 wherein the liquid gathering pipe is connected to deliver the liquid discharged from the separator on the skid, measured by the flow meter on the skid and periodically sampled by the automated liquid sampler on the skid to a central conditioning facility.

37. The method of claim 36 wherein the central oil conditioning facility comprises:
a plurality of pipes, each providing a liquid stream from a well; and
a liquid stabilizer to remove lighter hydrocarbon components from an aggregated stream of liquid that includes the plurality of the liquid streams.

38. The method of claim 31 wherein the gas gathering pipe that receives the gas discharged through from the separator gas discharge flange is connected to deliver the gas to a central gas processing facility.

39. The method of claim 8 wherein the central gas processing facility comprises a plurality of pipes, each providing a gas stream from a well; and
a gas scrubber to remove heavier hydrocarbon components from an aggregated stream of gas that includes the plurality of the gas streams.

40. A system comprising:
a first skid supporting a first separator, a liquid pump, a pump motor coupled to the liquid pump, an automated liquid sampler, and a flow meter, the separator having a liquid/gas interface sensor, an inlet flange, a gas discharge flange and a liquid discharge flange thereon;
a second skid supporting a second separator that is smaller in capacity than the first separator, a liquid pump, a pump motor coupled to the liquid pump, an automated liquid sampler, and a flow meter, the second separator having a liquid/gas interface sensor, an inlet flange, a gas discharge flange and a liquid discharge flange thereon;
a docking station having a second end of a flow line connected at a first end to a producing well and having a flange at the second end to facilitate the connection of the well to the inlet flange of one of the first and second separators, a gas gathering pipe with a flange to facilitate connection to one of the gas discharge flanges of the first and second separators, a liquid gathering pipe with a flange to facilitate connection to the liquid discharge flanges of the first and second separators, and a skid support adjacent the docking station to receive and support one of the first skid and the second skid;
a back pressure control valve fluidically coupled to dispose the flow meter and the automated liquid sampler intermediate the back pressure control valve and the liquid pump on one of the first and second skids;
one or more controllers to receive a signal from the liquid/gas interface sensor of one of the first and second separators, to receive a signal from a pressure sensor disposed to detect a pressure in one of the separators on the first skid and the second skid, to receive a signal from a pressure sensor disposed to detect a pressure intermediate the liquid pump of one of the first and second skids and the back pressure control valve, to generate a speed control signal to one of the pump motors of the first and second skids, and to generate a positioning signal to the back pressure control valve;
wherein the flange on the second end of the flow line, the flange on the gas gathering pipe and the flange on the liquid gathering pipe are positioned at the docking station to be coupled to the inlet flange, the gas discharge flange and the liquid discharge flange on the first separator, respectively, when the first skid is supported on the skid support, and to engage the inlet flange, the gas discharge flange and the liquid discharge flange on the second separator, respectively, when the second skid is supported on the skid support;
wherein the controller maintains the liquid/gas interface position of one of the separators on the first and second skids within a predetermined range by increasing the speed of the pump motor on one of the first and second skids in response to the detection of an elevated liquid/gas interface position in one of the first and second separators, and by subsequently decreasing the speed of the pump motor in response to detection of an corrected liquid/gas interface position in the one of the first and second separators; and
wherein the controller maintains the pressure intermediate the pump of one of the first and second skids and the back pressure control valve at a predetermined amount above the detected pressure in one of the separators on the first skid and the second skid.

41. The system of claim 40 wherein the controller maintains the liquid/gas interface position of one of the separators on the first and second skids within a predetermined range by generating a signal to a variable frequency drive coupled to a current source to condition a current to the pump motor on one of the first and second skids.

42. The system of claim 40 wherein the liquid pump is a centrifugal pump.

43. The system of claim 41 wherein the first separator on the first skid has a larger capacity than the second separator on the second skid.

44. The system of claim 40 wherein a gas discharge pipe is provided intermediate the gas discharge flange on one of the first and second separators and the gas gathering pipe flange of the docking station and a liquid discharge pipe is provided intermediate the liquid discharge flange on the one of the first and second separators and the liquid gathering pipe flange of the docking station when the one of the first and second separators is supported on the skid support.

45. A system comprising:
a container of chemical agent;
a chemical injection pump to receive the chemical agent from the container and to inject the chemical agent into a flow stream of liquid produced to the surface from a geologic formation;
an electrically-powered positive displacement chemical injection pump motor to operate the chemical injection pump at a variable speed;
a flow meter to detect the rate of flow of the liquid stream;
a controller to receive a signal from the flow meter corresponding to the detected rate of flow of the liquid stream; and
a current conditioning device to receive a current from a current source, to receive a signal from the controller corresponding to a current needed to obtain a targeted chemical agent concentration in the liquid flow stream, and to provide a conditioned current to the chemical injection pump motor to operate the chemical injection pump at a rate to provide the targeted chemical agent concentration.

46. The system of claim 45 wherein the current source is an alternating current electrical distribution grid.

47. The system of claim 45 wherein the chemical agent is one of an emulsion breaker, a scale inhibitor, a corrosion inhibitor, a paraffin inhibitor, and a friction reducer.

48. The system of claim 45 wherein the current conditioning device is a variable frequency drive.

49. The system of claim 45 wherein the current source is a bank of batteries.

50. The system of claim 49 wherein the batteries are coupled to one or more solar panels for being periodically recharged.

51. The system of claim 49 wherein the batteries are coupled to a generator for being periodically recharged; and
wherein the controller monitors a charge level of the bank of batteries and automatically activates the generator upon detecting a low charge level.

52. The system of claim 51 wherein the generator is powered by gas discharged from a separator that provides the liquid flow stream.
